(19) United States
(12) Patent Application Publication
(10) Pub. No.: US 2022/0167636 A1
(43) Pub. Date: Jun. 2, 2022

(54) SMOKER BOXES HAVING SLIDABLE LIDS

(71) Applicant: Weber-Stephen Products LLC, Palatine, IL (US)

(72) Inventors: Douglas W. Masek, Palatine, IL (US); James Keclik, McHenry, IL (US); Rome Ish-Hurwitz, Chicago, IL (US); Mohammed Shoeb, Hoffman Estates, IL (US)

(21) Appl. No.: 17/452,375

(22) Filed: Oct. 26, 2021

Related U.S. Application Data
(60) Provisional application No. 63/120,538, filed on Dec. 2, 2020.

(51) Int. Cl. A23B 4/044; A47J 37/07

(52) U.S. Cl. CPC A23B 4/044; A47J 37/0786

(57) ABSTRACT

Example smoker boxes having slidable lids are disclosed. An example smoker box includes a base and a lid. The base includes a bottom wall, a front wall extending upwardly from the bottom wall, a rear wall extending upwardly from the bottom wall, a right sidewall extending upwardly from the bottom wall, a left sidewall extending upwardly from the bottom wall, a first pin coupled to the right sidewall, and a second pin coupled to the left sidewall. The lid includes is slidably coupled to the base and movable between a closed position and an open position. The lid includes a top wall, a right lip extending downwardly from the top wall, and a left lip extending downwardly from the top wall. The right lip includes a first slot, and the left lip includes a second slot. The first pin extends into and is slidable within the first slot. The second pin extends into and is slidable within the second slot.

### RELATED APPLICATIONS

This application claims priority to U.S. Provisional Patent Application No. 63/120,538, filed Dec. 2, 2020. The entirety of U.S. Provisional Patent Application No. 63/120,538 is hereby incorporated by reference herein.

### FIELD OF THE DISCLOSURE

This disclosure relates generally to smoker boxes and, more specifically, to smoker boxes having slidable lids.

### BACKGROUND

Smoker boxes are routinely used in connection with grills (e.g., gas grills, charcoal grills, electric grills, etc.) to enhance the flavor of one or more food item(s) being cooked on a cooking surface of the grill. Some known smoker boxes include a base configured to be positioned directly on one or more cooking grate(s) of the grill. Other known smoker boxes include a base configured to be positioned below the cooking grate(s) of the grill and directly on one or more grease deflection bar(s) of the grill. Some known smoker boxes have lids that are not mechanically coupled to the base of the smoker box. Other known smoker boxes have lids that are rotatably hinged to the base of the smoker box such that the lid can be flipped and/or rotated relative to the base between a closed position and an open position.

### BRIEF DESCRIPTION OF THE DRAWINGS

FIG. 1 is a perspective view of an example smoker box constructed in accordance with teachings of this disclosure, with an example lid of the smoker box shown in an example closed position relative to an example base of the smoker box.

FIG. 2 is a front view of the smoker box of FIG. 1, with the lid of the smoker box shown in the closed position of FIG. 1.

FIG. 3 is a rear view of the smoker box of FIGS. 1 and 2, with the lid of the smoker box shown in the closed position of FIGS. 1 and 2.

FIG. 4 is a right side view of the smoker box of FIGS. 1-3, with the lid of the smoker box shown in the closed position of FIGS. 1-3.

FIG. 5 is a left side view of the smoker box of FIGS. 1-4, with the lid of the smoker box shown in the closed position of FIGS. 1-4.

FIG. 6 is a top view of the smoker box of FIGS. 1-5, with the lid of the smoker box shown in the closed position of FIGS. 1-5.

FIG. 7 is a bottom view of the smoker box of FIGS. 1-6, with the lid of the smoker box shown in the closed position of FIGS. 1-6.

FIG. 8 is a cross-sectional view of the smoker box of FIGS. 1-7 taken along section A-A of FIG. 6, with the lid of the smoker box shown in the closed position of FIGS. 1-7.

FIG. 9 is a cross-sectional view of the smoker box of FIGS. 1-8 taken along section B-B of FIG. 6, with the lid of the smoker box shown in the closed position of FIGS. 1-8.

FIG. 10 is a perspective view of the smoker box of FIGS. 1-9, with the lid of the smoker box shown in an example open position relative to the base of the smoker box.

FIG. 11 is a right side view of the smoker box of FIGS. 1-10, with the lid of the smoker box shown in the open position of FIG. 10.

FIG. 12 is a left side view of the smoker box of FIGS. 1-11, with the lid of the smoker box shown in the open position of FIGS. 10 and 11.

FIG. 13 is a perspective view of an example grill including the smoker box of FIGS. 1-12, with the lid of the smoker box shown in the closed position of FIGS. 1-9.

FIG. 14 is a top view of the smoker box of FIGS. 1-13 located within the cookbox of FIG. 13, with the lid of the smoker box shown in the closed position of FIGS. 1-9 and 13.

FIG. 15 is a top view of the smoker box of FIGS. 1-14 located within the cookbox of FIGS. 13 and 14, with the lid of the smoker box shown in the closed position of FIGS. 1-9, 13, and 14, and with the cooking grate(s) of FIGS. 13 and 14 shown removed from the cookbox.

FIG. 16 is a cross-sectional view taken along section C-C of FIG. 14 showing the smoker box of FIGS. 1-15 located within the cookbox of FIGS. 13-15, with the lid of the smoker box shown in the closed position of FIGS. 1-9 and 13-15.

FIG. 17 is a top view of the smoker box of FIGS. 1-16 located within the cookbox of FIGS. 13-16, with the lid of the smoker box shown in the open position of FIGS. 10-12.

FIG. 18 is a top view of the smoker box of FIGS. 1-17 located within the cookbox of FIGS. 13-17, with the lid of the smoker box shown in the open position of FIGS. 10-12 and 17, and with the cooking grate(s) of FIGS. 13, 14, 16 and 17 shown removed from the cookbox.

FIG. 19 is a perspective view of another example smoker box constructed in accordance with teachings of this disclosure, with an example lid of the smoker box shown in an example closed position relative to an example base of the smoker box.

FIG. 20 is a front view of the smoker box of FIG. 19, with the lid of the smoker box shown in the closed position of FIG. 19.

FIG. 21 is a rear view of the smoker box of FIGS. 19 and 20, with the lid of the smoker box shown in the closed position of FIGS. 19 and 20.

FIG. 22 is a right side view of the smoker box of FIGS. 19-21, with the lid of the smoker box shown in the closed position of FIGS. 19-21.

FIG. 23 is a left side view of the smoker box of FIGS. 19-22, with the lid of the smoker box shown in the closed position of FIGS. 19-22.

FIG. 24 is a top view of the smoker box of FIGS. 19-23, with the lid of the smoker box shown in the closed position of FIGS. 19-23.

FIG. 25 is a bottom view of the smoker box of FIGS. 19-24, with the lid of the smoker box shown in the closed position of FIGS. 19-24.

FIG. 26 is a cross-sectional view of the smoker box of FIGS. 19-25 taken along section D-D of FIG. 24, with the lid of the smoker box shown in the closed position of FIGS. 19-25.

FIG. 27 is a cross-sectional view of the smoker box of FIGS. 19-26 taken along section E-E of FIG. 24, with the lid of the smoker box shown in the closed position of FIGS. 19-26.

FIG. 28 is a perspective view of the smoker box of FIGS. 19-27, with the lid of the smoker box shown in an example open position relative to the base of the smoker box.

FIG. 29 is a right side view of the smoker box of FIGS. 19-28, with the lid of the smoker box shown in the open position of FIG. 28.

FIG. 30 is a left side view of the smoker box of FIGS. 19-29, with the lid of the smoker box shown in the open position of FIGS. 28 and 29.

FIG. 31 is a top view of the smoker box of FIGS. 19-30 located within the cookbox of FIG. 13, with the lid of the smoker box shown in the closed position of FIGS. 19-27.

FIG. 32 is a top view of the smoker box of FIGS. 19-31 located within the cookbox of FIGS. 13 and 31, with the lid of the smoker box shown in the closed position of FIGS. 19-27 and 31, and with the cooking grate(s) of FIGS. 13 and 31 shown removed from the cookbox.

FIG. 33 is a cross-sectional view taken along section F-F of FIG. 31 showing the smoker box of FIGS. 19-32 located within the cookbox of FIGS. 13, 31 and 32, with the lid of the smoker box shown in the closed position of FIGS. 19-27, 31, and 32.

FIG. 34 is a top view of the smoker box of FIGS. 19-33 located within the cookbox of FIGS. 13 and 31-33, with the lid of the smoker box shown in the open position of FIGS. 28-30.

FIG. 35 is a top view of the smoker box of FIGS. 19-34 located within the cookbox of FIGS. 13 and 31-34, with the lid of the smoker box shown in the open position of FIGS. 28-30 and 34, and with the cooking grate(s) of FIGS. 13, 31, 33 and 34 shown removed from the cookbox.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Example smoker boxes disclosed herein have slidable lids that provide enhanced usability and consumer experience opportunities with regard to opening and/or closing the lid of the smoker box relative to the base of the smoker box. In some disclosed examples, the smoker box includes a base having a bottom wall, a front wall, a rear wall, a right sidewall, a left sidewall, a first pin coupled to the right sidewall, and a second pin coupled to the left sidewall. In some disclosed examples, the smoker box further includes a lid slidably coupled to the base and movable between a closed position and an open position. In some disclosed examples, the lid includes a top wall, a right lip, and a left lip. In some disclosed examples, the right lip includes a first slot, the left lip includes a second slot, the first pin extends into and is slidable within the first slot, and the second pin extends into and is slidable within the second slot.

The above-identified features as well as other advantageous features of example smoker boxes having slidable lids as disclosed herein are further described below in connection with the figures of the application. As used herein, the term “configured” means sized, shaped, arranged, structured, oriented, positioned and/or located. For example, in the context of a first object configured to fit within a second object, the first object is sized, shaped, arranged, structured, oriented, positioned and/or located to fit within the second object. As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary. For example, a plurality of trees can circumscribe a field.

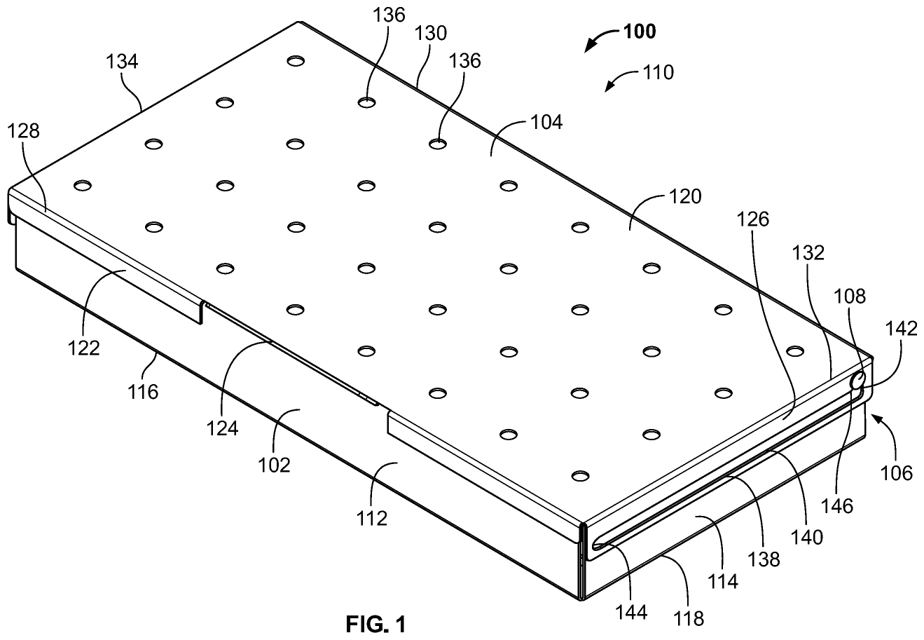

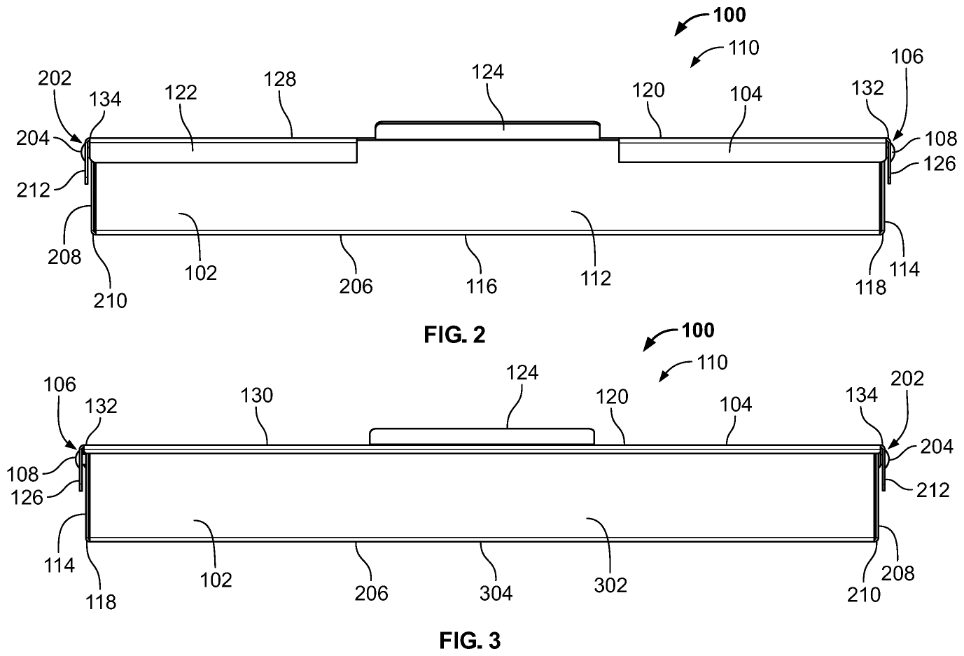

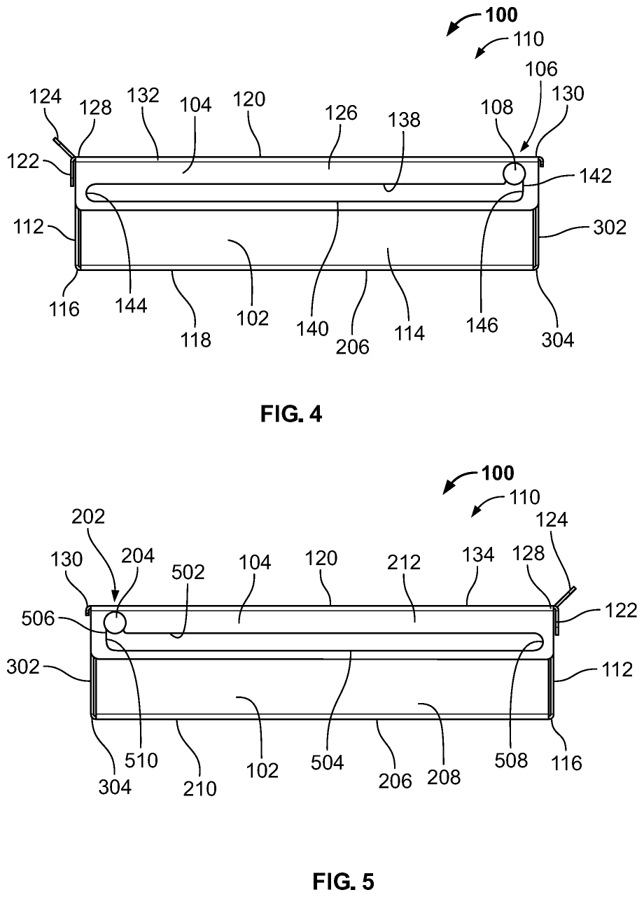

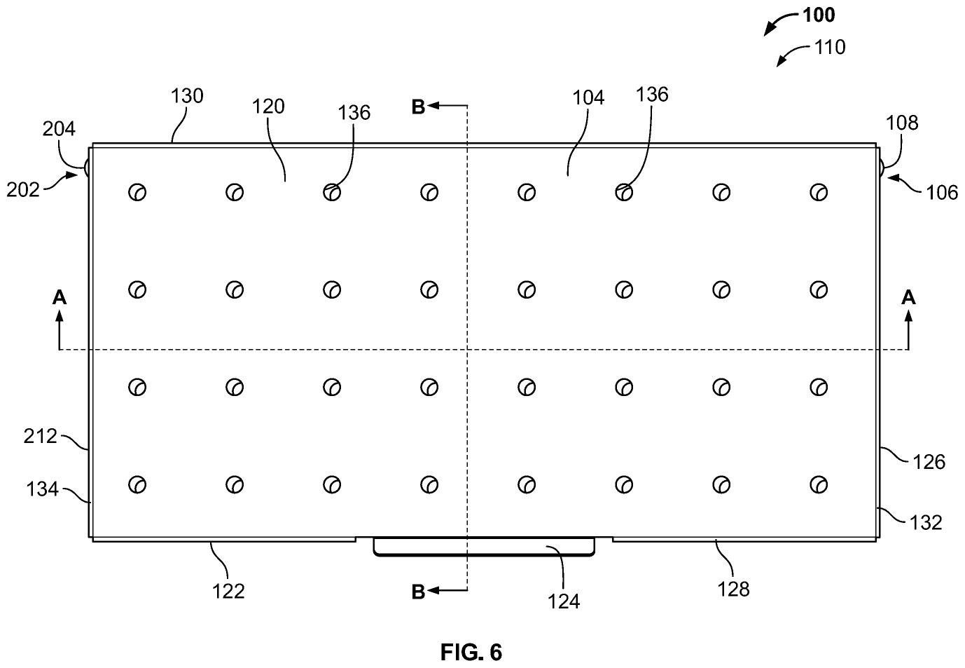

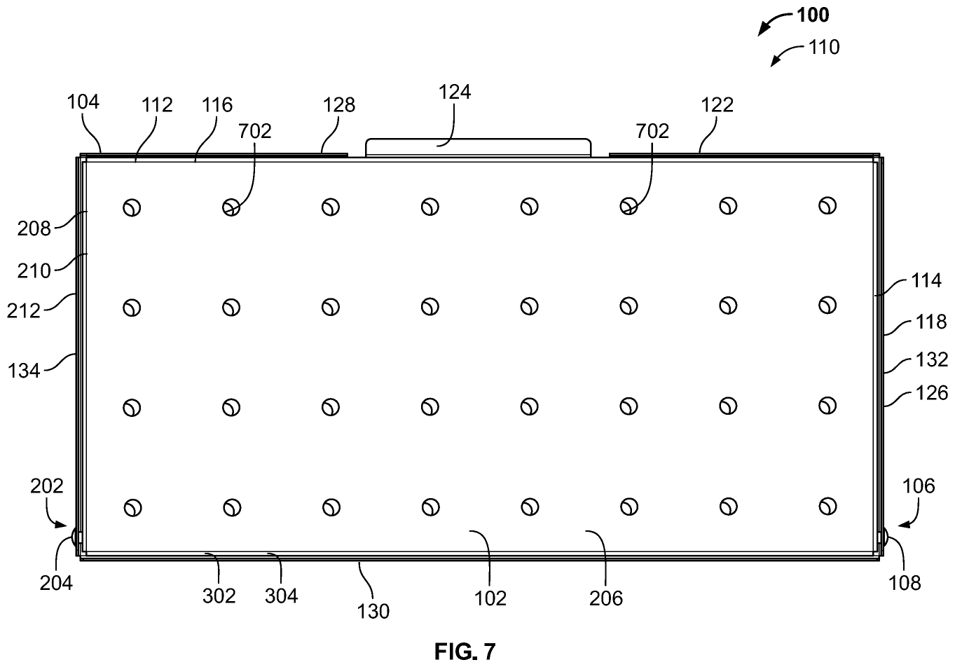

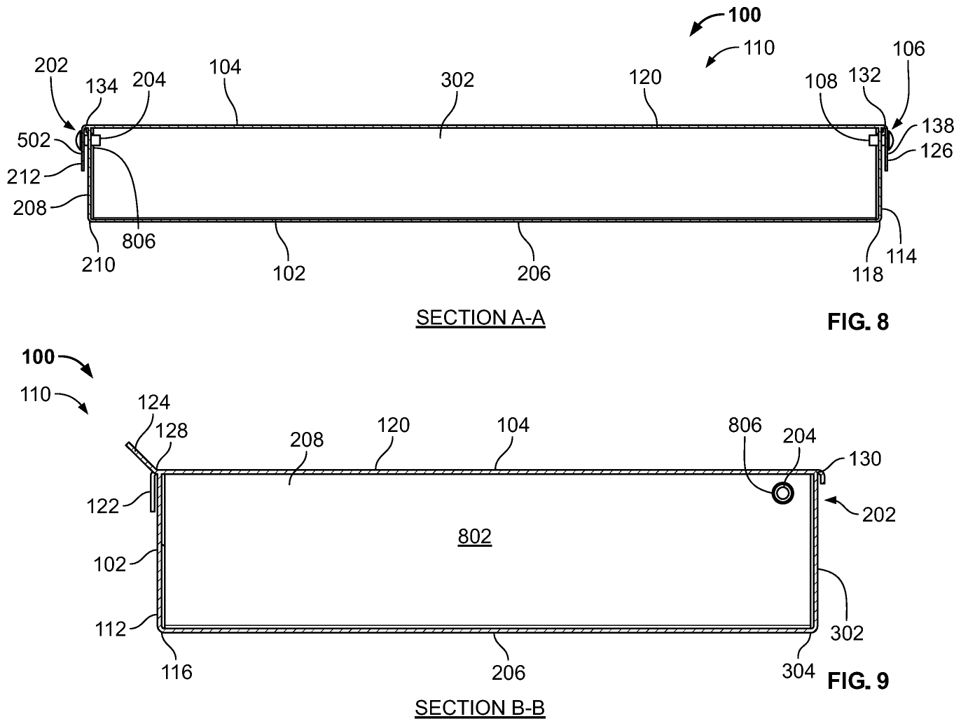

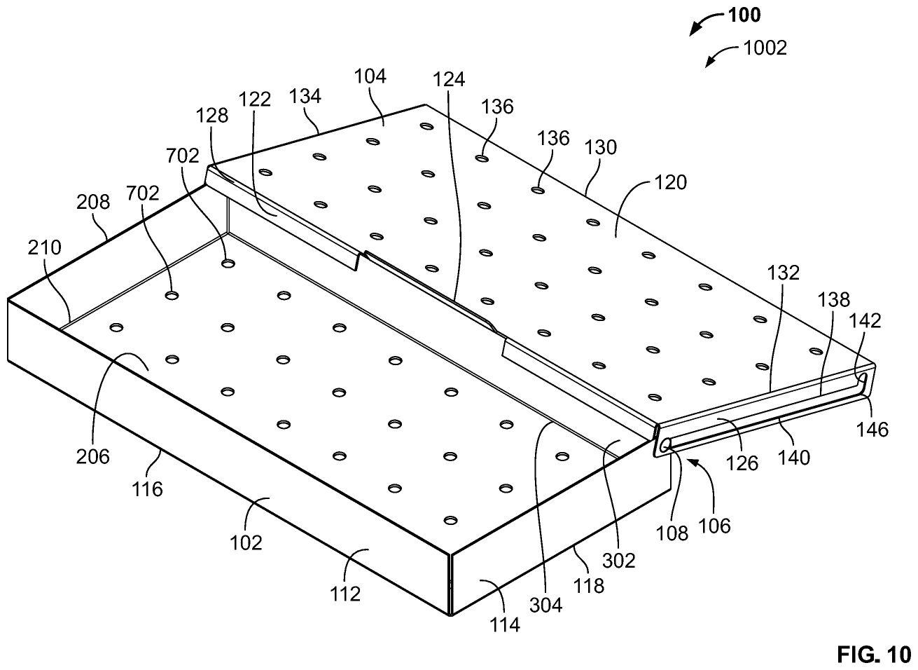

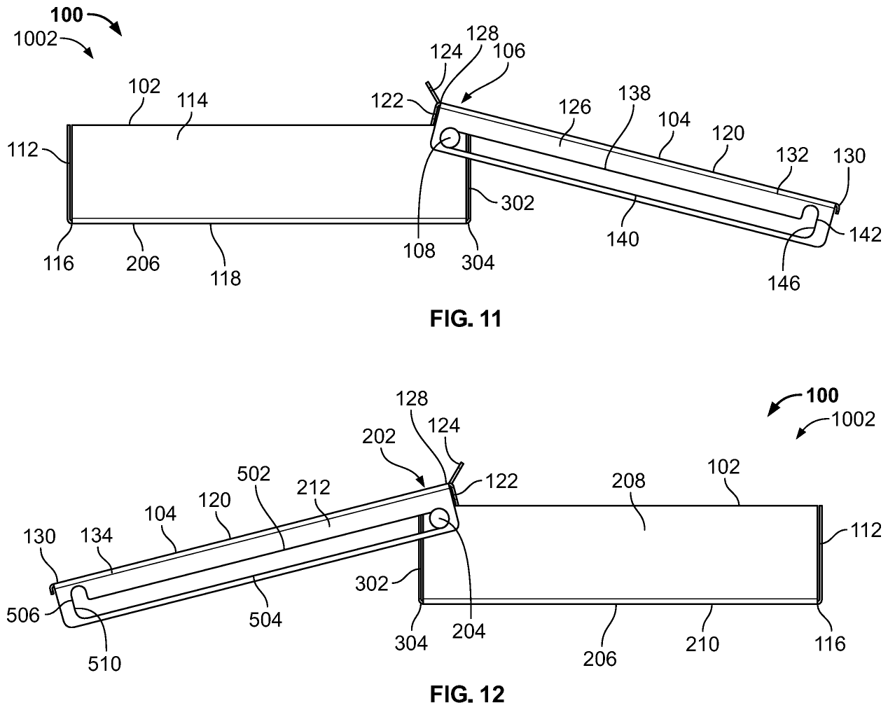

FIG. 1 is a perspective view of an example smoker box 100 constructed in accordance with teachings of this disclosure, with an example lid 104 of the smoker box 100 shown in an example closed position 110 relative to an example base 102 of the smoker box 100. FIG. 2 is a front view of the smoker box 100 of FIG. 1, with the lid 104 of the smoker box 100 shown in the closed position 110 of FIG. 1. FIG. 3 is a rear view of the smoker box 100 of FIGS. 1 and 2, with the lid 104 of the smoker box 100 shown in the closed position 110 of FIGS. 1 and 2. FIG. 4 is a right side view of the smoker box 100 of FIGS. 1-3, with the lid 104 of the smoker box 100 shown in the closed position 110 of FIGS. 1-3. FIG. 5 is a left side view of the smoker box 100 of FIGS. 1-4, with the lid 104 of the smoker box 100 shown in the closed position 110 of FIGS. 1-4. FIG. 6 is a top view of the smoker box 100 of FIGS. 1-5, with the lid 104 of the smoker box 100 shown in the closed position 110 of FIGS. 1-5. FIG. 7 is a bottom view of the smoker box 100 of FIGS. 1-6, with the lid 104 of the smoker box 100 shown in the closed position 110 of FIGS. 1-6. FIG. 8 is a cross-sectional view of the smoker box 100 of FIGS. 1-7 taken along section A-A of FIG. 6, with the lid 104 of the smoker box 100 shown in the closed position 110 of FIGS. 1-7. FIG. 9 is a cross-sectional view of the smoker box 100 of FIGS. 1-8 taken along section B-B of FIG. 6, with the lid 104 of the smoker box 100 shown in the closed position 110 of FIGS. 1-8. FIG. 10 is a perspective view of the smoker box 100 of FIGS. 1-9, with the lid 104 of the smoker box 100 shown in an example open position 1002 relative to the base 102 of the smoker box 100. FIG. 11 is a right side view of the smoker box 100 of FIGS. 1-10, with the lid 104 of the smoker box 100 shown in the open position 1002 of FIG. 10. FIG. 12 is a left side view of the smoker box 100 of FIGS. 1-11, with the lid 104 of the smoker box 100 shown in the open position 1002 of FIGS. 10 and 11.

In the illustrated example of FIGS. 1-12, the smoker box 100 includes the base 102, the lid 104, an example first hinge 106 having an example first pin 108, and an example second hinge 202 having an example second pin 204. The lid 104 of the smoker box 100 is slidably coupled to the base 102 of the smoker box 100 via the first hinge 106 and the second hinge 202 of the smoker box 100, with the lid 104 being movable (e.g., slidable) relative to the base 102 between the closed position 110 shown in FIGS. 1-9 and the open position 1002 shown in FIGS. 10-12.

The base 102 of the smoker box 100 of FIGS. 1-12 defines and/or provides an example compartment 802 that can be filled with solid-form smoking materials (e.g., wood chips, wood pellets, etc.) when the lid 104 of the smoker box 100 is in the open position 1002 shown in FIGS. 10-12. Once such smoking materials have been added to the compartment 802, the lid 104 of the smoker box 100 can be moved (e.g., slid) from the open position 1002 shown in FIGS. 10-12 into the closed position 110 shown in FIGS. 1-9 to retain the smoking materials within the compartment 802, and/or to facilitate a smoke-generating process within the compartment 802.

In the illustrated example of FIGS. 1-12, the base 102 of the smoker box 100 includes an example bottom wall 206, an example front wall 112, an example rear wall 302, an example right sidewall 114, and an example left sidewall 208. The bottom wall 206 of the base 102 includes an example front edge 116, an example rear edge 304 located opposite the front edge 116 of the bottom wall 206, an example right edge 118 extending between the front edge 116 and the rear edge 304 of the bottom wall 206, and an example left edge 210 located opposite the right edge 118 of the bottom wall 206 and extending between the front edge 116 and the rear edge 304 of the bottom wall 206. The bottom wall 206 of the base 102 has a substantially flat, planar profile defined by the front edge 116, the rear edge 304, the right edge 118, and the left edge 210 of the bottom wall 206. The base 102 of the smoker box 100 has a generally rectangular, box-shaped profile defined by the front edge 116, the rear edge 304, the right edge 118, and the left edge 210 of the bottom wall 206, and further defined by the front wall 112, the rear wall 302, the right sidewall 114, and the left sidewall 208.

The bottom wall 206 of the base 102 of FIGS. 1-12 further includes example openings 702 (e.g., example through holes) formed in and extending through the bottom wall 206. The openings 702 formed in the bottom wall 206 of the base 102 can be configured to have any size and/or any shape that is suitable for facilitating a smoke-generating process within the compartment 802 of the smoker box 100, while also preventing solid-form smoking materials (e.g., wood chips, wood pellets, etc.) contained within the compartment 802 from passing through the bottom wall 206 of the base 102. The openings 702 formed in the bottom wall 206 of the base 102 can be configured according to any layout, pattern, and or arrangement that facilitates a smoke-generating process within the compartment 802 of the smoker box 100.

The front wall 112 of the base 102 of FIGS. 1-12 extends upwardly from the front edge 116 of the bottom wall 206 of the base 102. The rear wall 302 of the base 102 of FIGS. 1-12 extends upwardly from the rear edge 304 of the bottom wall 206 of the base 102. The right sidewall 114 of the base 102 of FIGS. 1-12 extends upwardly from the right edge 118 of the bottom wall 206 of the base 102. The left sidewall 208 of the base 102 of FIGS. 1-12 extends upwardly from the left edge 210 of the bottom wall 206 of the base 102. In the illustrated example of FIGS. 1-12, the front wall 112, the rear wall 302, the right sidewall 114, and the left sidewall 208 of the base 102 have respective rectangular profiles defined in part by corresponding ones of the front edge 116, the rear edge 304, the right edge 118, and the left edge 210 of the bottom wall 206 of the base 102. In other examples, one or more of the front wall 112, the rear wall 302, the right sidewall 114, and/or the left sidewall 208 of the base 102 can instead have a non-rectangular rectangular profile (e.g., a triangular profile, a trapezoidal profile, a hexagonal profile, etc.) defined in part by a corresponding one of the front edge 116, the rear edge 304, the right edge 118, and/or the left edge 210 of the bottom wall 206 of the base 102.

The right sidewall 114 of the base 102 of FIGS. 1-12 includes an example opening 804 (e.g., a through hole) formed in and extending through the right sidewall 114, with the opening 804 being configured to receive the first pin 108 of the first hinge 106. The left sidewall 208 of the base 102 of FIGS. 1-12 includes an example opening 806 (e.g., a through hole) formed in and extending through the left sidewall 208, with the opening 806 being configured to receive the second pin 204 of the second hinge 202. In the illustrated example of FIGS. 1-12, the opening 804 formed in the right sidewall 114 of the base 102 is coaxially aligned with the opening 806 formed in the left sidewall 208 of the base 102, and the first pin 108 of the first hinge 106 is coaxially aligned with the second pin 204 of the second hinge 202.

The base 102 of the smoker box 100 of FIGS. 1-12 has a depth (DB) extending from the front edge 116 of the bottom wall 206 to the rear edge 304 of the bottom wall 206, and a width (WB) extending from the right edge 118 of the bottom wall 206 to the left edge 210 of the bottom wall 206. In the illustrated example of FIGS. 1-12, the base 102 of the smoker box 100 is configured such that the width (WB) of the base 102 exceeds the depth (DB) of the base 102. In other examples, the base 102 of the smoker box 100 can instead be configured such that the depth (DB) of the base 102 is greater than or equal to the width (WB) of the base 102.

In the illustrated example of FIGS. 1-12, the base 102 of the smoker box 100 is configured such that the width (WB) of the base 102 is large enough to facilitate the bottom wall 206 of the base 102 being placed into simultaneous contact with the respective tops of at least three neighboring grease deflection bars located within a cookbox of a grill, as further described below. In other examples, the base 102 of the smoker box 100 can instead be configured such that the width (WB) of the base 102 is large enough to facilitate the bottom wall 206 of the base 102 being placed into simultaneous contact with the respective tops of at least two neighboring grease deflection bars located within a cookbox of a grill.

In the illustrated example of FIGS. 1-12, the lid 104 of the smoker box 100 includes an example top wall 120, an example front lip 122, an example front tab 124, an example right lip 126, and an example left lip 212. The top wall 120 of the lid 104 includes an example front edge 128, an example rear edge 130 located opposite the front edge 128 of the top wall 120, an example right edge 132 extending between the front edge 128 and the rear edge 130 of the top wall 120, and an example left edge 134 located opposite the right edge 132 of the top wall 120 and extending between the front edge 128 and the rear edge 130 of the top wall 120. The top wall 120 of the lid 104 has a substantially flat, planar profile defined by the front edge 128, the rear edge 130, the right edge 132, and the left edge 134 of the top wall 120.

The top wall 120 of the lid 104 of FIGS. 1-12 further includes example openings 136 (e.g., example through holes) formed in and extending through the top wall 120. The openings 136 formed in the top wall 120 of the lid 104 can be configured to have any size and/or any shape that is suitable for facilitating a smoke-generating process within the compartment 802 of the smoker box 100, while also preventing solid-form smoking materials (e.g., wood chips, wood pellets, etc.) contained within the compartment 802 from passing through the top wall 120 of the lid 104. The openings 136 formed in the top wall 120 of the lid 104 can be configured according to any layout, pattern, and or arrangement that facilitates a smoke-generating process within the compartment 802 of the smoker box 100.

The front lip 122 of the lid 104 of FIGS. 1-12 extends downwardly from the front edge 128 of the top wall 120 of the lid 104. The front tab 124 of the lid 104 of FIGS. 1-12 extends forwardly and/or upwardly from the front edge 128 of the top wall 120 of the lid 104, with the front tab 124 being centrally located along the front edge 128 of the top wall 120. The right lip 126 of the lid 104 of FIGS. 1-12 extends downwardly from the right edge 132 of the top wall 120 of the lid 104. The left lip 212 of the lid 104 of FIGS. 1-12 extends downwardly from the left edge 134 of the top wall 120 of the lid 104. In the illustrated example of FIGS. 1-12, the front lip 122, the front tab 124, the right lip 126, and the left lip 212 of the lid 104 have respective rectangular profiles defined in part by corresponding ones of the front edge 128, the right edge 132, and the left edge 134 of the top wall 120 of the lid 104. In other examples, one or more of the front lip 122, the front tab 124, the right lip 126, and/or the left lip 212 of the lid 104 can instead have a non-rectangular rectangular profile (e.g., a triangular profile, a trapezoidal profile, a hexagonal profile, etc.) defined in part by a corresponding one of the front edge 128, the right edge 132, and/or the left edge 134 of the top wall 120 of the lid 104.

The lid 104 of the smoker box 100 of FIGS. 1-12 has a depth (DL) extending from the front edge 128 of the top wall 120 to the rear edge 130 of the top wall 120, and a width (WL) extending from the right edge 132 of the top wall 120 to the left edge 134 of the top wall 120. In the illustrated example of FIGS. 1-12, the lid 104 of the smoker box 100 is configured such that the depth (DL) and the width (WL) of the lid 104 exceed the corresponding depth (DB) and the corresponding width (WB) of the base 102 of the smoker box 100. In this regard, the lid 104 of the smoker box 100 is configured such that the depth (DL) and the width (WL) of the lid 104 are large enough to locate the respective ones of the front edge 128, the rear edge 130, the right edge 132, and the left edge 134 of the top wall 120 of the lid 104 outwardly of, from, and/or relative to the corresponding respective ones of the front edge 116, the rear edge 304, the right edge 118, and the left edge 210 of the bottom wall 206 of the base 102 of the smoker box 100. In this same regard, the lid 104 of the smoker box 100 is configured such that the depth (DL) and the width (WL) of the lid 104 are large enough to locate the respective ones of the front lip 122, the right lip 126, and the left lip 212 of the lid 104 outwardly of, from, and/or relative to the corresponding respective ones of the front wall 112, the right sidewall 114, and the left sidewall 208 of the base 102 of the smoker box 100.

The right lip 126 of the lid 104 of FIGS. 1-12 includes an example slot 138 (e.g., a slotted through hole) formed in and extending through the right lip 126. The slot 138 of the right lip 126 is configured to receive the first pin 108 of the first hinge 106 (e.g., such that the first pin 108 extends into and/or through the slot 138) to slidably couple the lid 104 of the smoker box 100 to the base 102 of the smoker box 100. The slot 138 of the right lip 126 of the lid 104 accordingly forms part of the first hinge 106 of the smoker box 100. In the illustrated example of FIGS. 1-12, the slot 138 formed in the right lip 126 has an L-shaped profile including and/or defined by an example linear portion 140 and an example notch 142 extending upwardly from the linear portion 140 of the slot 138. The linear portion 140 of the slot 138 includes an example front end 144 and an example rear end 146 located opposite the front end 144 of the slot 138. The notch 142 of the slot 138 is located at the rear end 146 of the linear portion 140 of the slot 138.

The left lip 212 of the lid 104 of FIGS. 1-12 includes an example slot 502 (e.g., a slotted through hole) formed in and extending through the left lip 212. The slot 502 of the left lip 212 is configured to receive the second pin 204 of the second hinge 202 (e.g., such that the second pin 204 extends into and/or through the slot 502) to slidably couple the lid 104 of the smoker box 100 to the base 102 of the smoker box 100. The slot 502 of the left lip 212 of the lid 104 accordingly forms part of the second hinge 202 of the smoker box 100. In the illustrated example of FIGS. 1-12, the slot 502 formed in the left lip 212 has an L-shaped profile including and/or defined by an example linear portion 504 and an example notch 506 extending upwardly from the linear portion 504 of the slot 502. The linear portion 504 of the slot 502 includes an example front end 508 and an example rear end 510 located opposite the front end 508 of the slot 502. The notch 506 of the slot 502 is located at the rear end 510 of the linear portion 504 of the slot 502.

In the illustrated example of FIGS. 1-12, the slot 138 formed in the right lip 126 of the lid 104 is coaxially aligned with the slot 502 formed in the left lip 212 of the lid 104, with the slot 502 formed in the left lip 212 of the lid 104 being configured as a mirror image of the slot 138 formed in the right lip 126 of the lid 104. When the lid 104 of the smoker box 100 is in the closed position 110 (e.g., as shown in FIGS. 1-9) relative to the base 102 of the smoker box 100, the first pin 108 of the first hinge 106 is located and/or positioned within the notch 142 of the slot 138 of the right lip 126 of the lid 104, and the second pin 204 of the second hinge 202 is located and/or positioned within the notch 506 of the slot 502 of the left lip 212 of the lid 104. When the lid 104 of the smoker box 100 is in the open position 1002 (e.g., as shown in FIGS. 10-12) relative to the base 102 of the smoker box 100, the first pin 108 of the first hinge 106 is located and/or positioned within the linear portion 140 of the slot 138 of the right lip 126 of the lid 104 (e.g., the first pin 108 being adjacent or proximate the front end 144 of the linear portion 140 of the slot 138), and the second pin 204 of the second hinge 202 is located and/or positioned within the linear portion 504 of the slot 502 of the left lip 212 of the lid 104 (e.g., the second pin 204 being adjacent or proximate the front end 508 of the linear portion 504 of the slot 502).

Movement (e.g., sliding movement) of the lid 104 of the smoker box 100 relative to the base 102 of the smoker box 100 between the closed position 110 shown in FIGS. 1-9 and the open position 1002 shown in FIGS. 10-12 can be facilitated via the front tab 124 of the lid 104 of the smoker box 100. In this regard, the front tab 124 of the lid 104 can be used to lift and/or push the lid 104 from the closed position 110 shown in FIGS. 1-9 into the open position 1002 shown in FIGS. 10-12. Sliding the lid 104 from the closed position 110 shown in FIGS. 1-9 into the open position 1002 shown in FIGS. 10-12 exposes the compartment 802 of the smoker box 100, as may be desired to facilitate adding and/or removing solid-form smoking materials to and/or from the compartment 802. Conversely, the front tab 124 of the lid 104 can be used to pull and/or lower the lid 104 from the open position 1002 shown in FIGS. 10-12 into the closed position 110 shown in FIGS. 1-9. Sliding the lid 104 from the open position 1002 shown in FIGS. 10-12 into the closed position 110 shown in FIGS. 1-9 covers the compartment 802 of the smoker box 100, as may be desired to facilitate a smoke-generating process within the compartment 802.

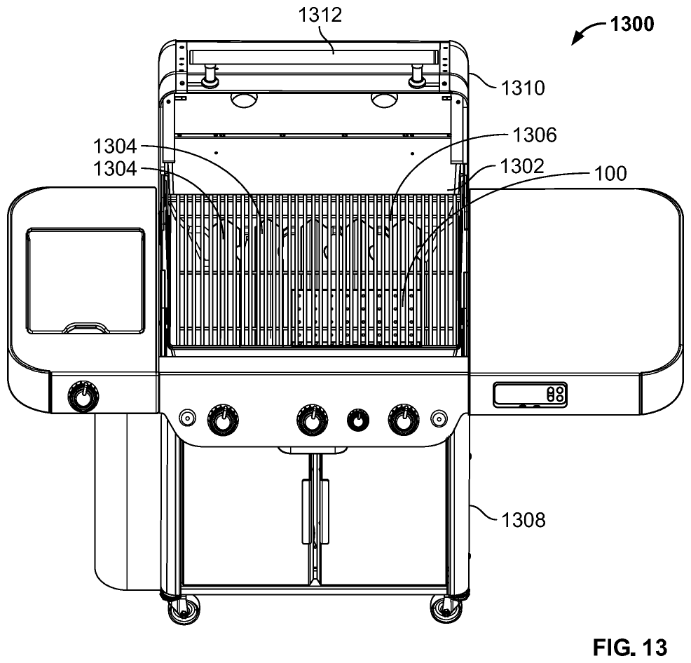

FIG. 13 is a perspective view of an example grill 1300 including the smoker box 100 of FIGS. 1-12, with the lid 104 of the smoker box 100 shown in the closed position of FIGS. 1-9. The grill 1300 of FIG. 13 further includes an example cookbox 1302, one or more example grease deflection bar(s) 1304, one or more example cooking grate(s) 1306, an example base 1308, and an example lid 1310. The cookbox 1302 of the grill 1300 can house, carry, and/or otherwise include a heat-generating and/or heat-emitting structure positioned within the cookbox 1302. For example, in instances where the grill 1300 is a gas grill, the cookbox 1302 of the grill 1300 can house, carry, and/or otherwise include one or more burner tube(s) configured to generate and/or emit a heat-producing gas flame. As another example, in instances where the grill 1300 is a solid-fuel grill (e.g., a charcoal grill, a pellet grill, etc.), the cookbox 1302 of the grill 1300 can house, carry, and/or otherwise include a burn pot and/or a burn pit configured to generate and/or emit heat from charcoal and/or wood pellets being combusted thereon or therein.

The cookbox 1302 of the grill 1300 further includes the cooking grate(s) 1306, with the cooking grate(s) 1306 being located and/or positioned within the cookbox 1302 above the aforementioned heat-generating and/or heat-emitting structure(s) of the cookbox 1302, and/or above the grease deflection bar(s) 1304 of the cookbox 1302. The cooking grate(s) 1306 is/are configured to form and/or define a substantially flat, planar cooking surface for cooking one or more food item(s) placed thereon. As shown in FIG. 13, the cooking grate(s) 1306 is/are configured to fill, cover, and/or occupy the substantial entirety of the horizontal form factor and/or footprint of the cookbox 1302 (e.g., as defined by the width and the depth of the cookbox 1302). In other examples, the cooking grate(s) 1306 can instead be configured to fill, cover, and/or occupy a relatively smaller portion and/or percentage (e.g., less than the substantial entirety) of the horizontal form factor and/or footprint of the cookbox 1302.

The cookbox 1302 of the grill 1300 further includes the grease deflection bar(s) 1304, with the grease deflection bar(s) 1304 being located and/or positioned within the cookbox 1302 above the aforementioned heat-generating and/or heat-emitting structure(s) of the cookbox 1302 and below the cooking grate(s) 1306 of the cookbox 1302. The grease deflection bar(s) 1304 is/are configured to have an inverted V-shaped profile. The inverted V-shaped profile of the grease deflection bar(s) 1304 directs grease that drips from the cooking grate(s) 1306 onto the grease deflection bar(s) 1304 to a further downward location within the cookbox 1302 of the grill 1300, while also shielding the aforementioned heat-generating and/or heat-emitting structure(s) of the cookbox 1302 from being exposed to such grease. In the illustrated example of FIG. 13, the grill 1300 includes five grease deflection bars 1304 that are spaced apart from one another in a parallel, neighboring relationship, and arranged within the cookbox 1302 in a front-to rear-orientation.

The cookbox 1302 of the grill 1300 is coupled to, positioned on, and/or supported by the base 1308 of the grill 1300. The base 1308 can be structured as a cart, a storage compartment, a frame, and/or any number of legs that may be suitable to support the cookbox 1302. The lid 1310 of the grill 1300 is movably coupled (e.g., via one or more hinge(s) or pin(s)) to the cookbox 1302 of the grill 1300 in a manner that enables the lid 1310 to be moved (e.g., pivoted and/or rotated) relative to the cookbox 1302 between a closed position and an open position (e.g., as shown in FIG. 13). The cookbox 1302 and the lid 1310 collectively define a cooking chamber of the grill 1300, with said cooking chamber being fully formed when the lid 1310 is in the closed position. Placement of the lid 1310 in the open position enables a user to access the cookbox 1302, the cooking grate(s) 1306, and/or the cooking chamber of the grill 1300, as may be required to load, unload, and/or otherwise access a food item located therein or thereon. Placement of the lid 1310 in the open position also enables a user to access the smoker box 100, as may be required to load, unload, and/or otherwise access the smoker box 100 and/or solid-form smoking materials located therein or thereon Movement of the lid 1310 between the closed position and the open position can be performed by a user of the grill 1300 via an example handle 1312, with said handle 1312 being coupled and/or mounted to the lid 1310.

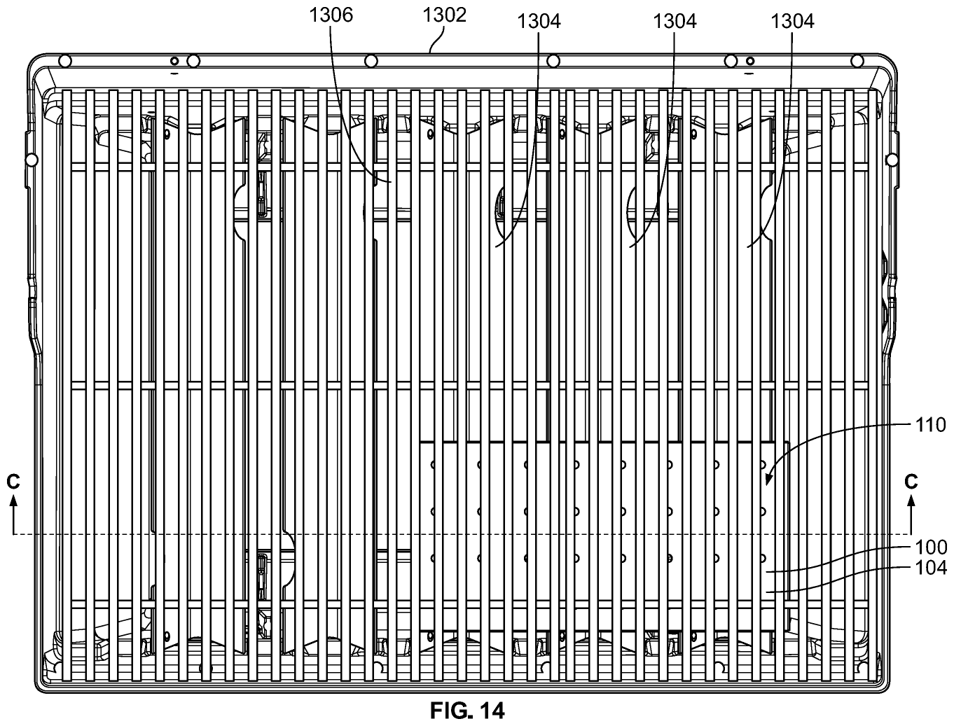

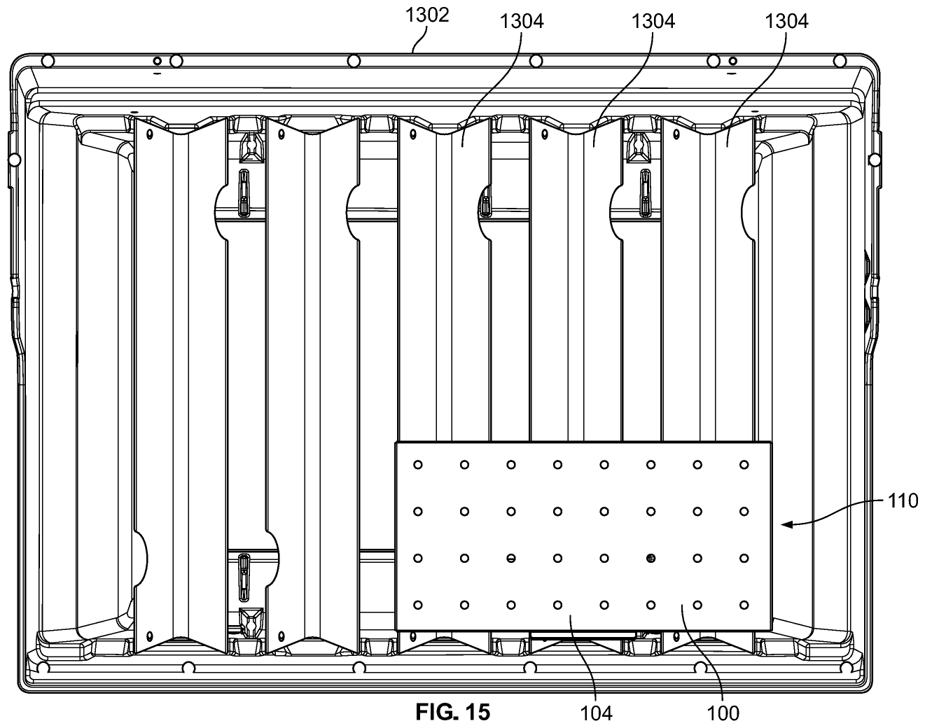

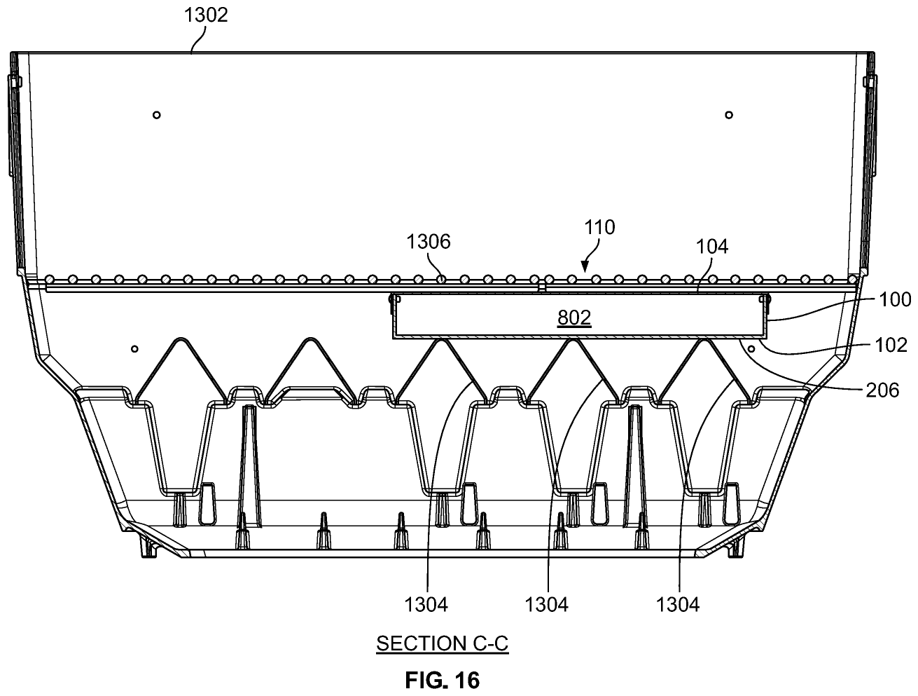

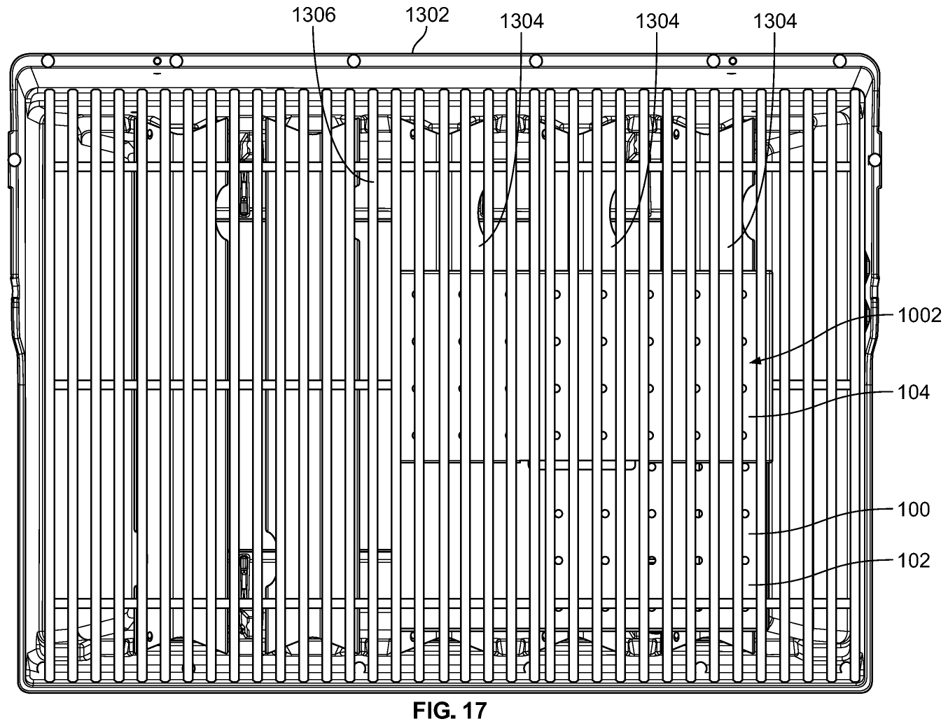

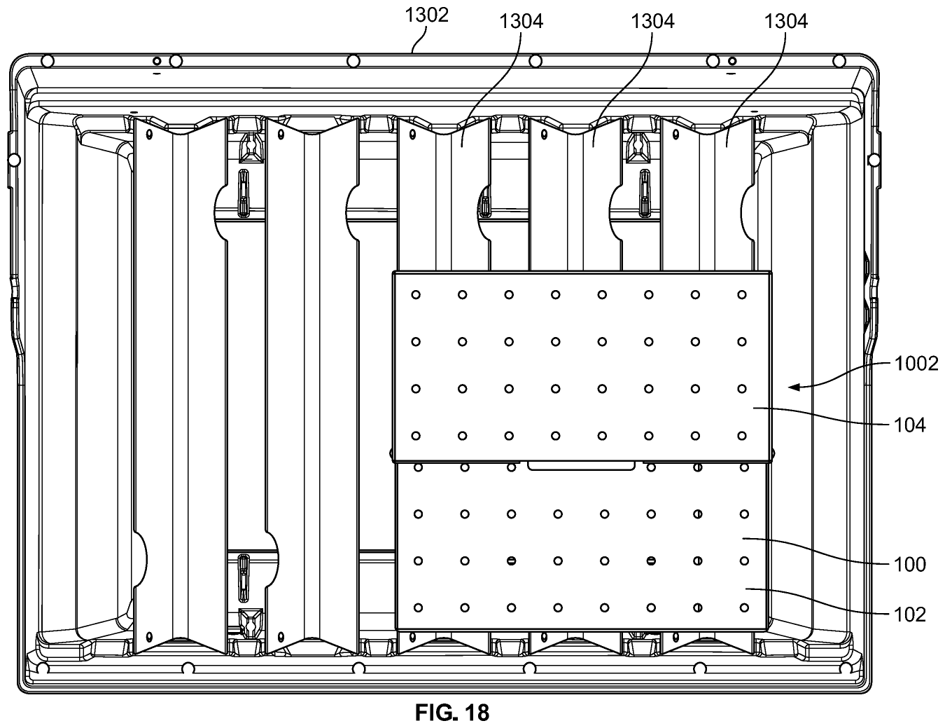

FIG. 14 is a top view of the smoker box 100 of FIGS. 1-13 located within the cookbox 1302 of FIG. 13, with the lid 104 of the smoker box 100 shown in the closed position 110 of FIGS. 1-9 and 13. FIG. 15 is a top view of the smoker box 100 of FIGS. 1-14 located within the cookbox 1302 of FIGS. 13 and 14, with the lid 104 of the smoker box 100 shown in the closed position 110 of FIGS. 1-9, 13, and 14, and with the cooking grate(s) 1306 of FIGS. 13 and 14 shown removed from the cookbox 1302. FIG. 16 is a cross-sectional view taken along section C-C of FIG. 14 showing the smoker box 100 of FIGS. 1-15 located within the cookbox 1302 of FIGS. 13-15, with the lid 104 of the smoker box 100 shown in the closed position 110 of FIGS. 1-9 and 13-15. FIG. 17 is a top view of the smoker box 100 of FIGS. 1-16 located within the cookbox 1302 of FIGS. 13-16, with the lid 104 of the smoker box 100 shown in the open position 1002 of FIGS. 10-12. FIG. 18 is a top view of the smoker box 100 of FIGS. 1-17 located within the cookbox 1302 of FIGS. 13-17, with the lid 104 of the smoker box 100 shown in the open position 1002 of FIGS. 10-12 and 17, and with the cooking grate(s) 1306 of FIGS. 13, 14, 16 and 17 shown removed from the cookbox 1302.

In the illustrated example of FIGS. 14-18, the smoker box 100 is located within the cookbox 1302 of the grill 1300 at a vertical position above the grease deflection bar(s) 1304 and below the cooking grate(s) 1306 of the grill 1300, with the base 102 (e.g., the bottom wall 206 of the base 102) of the smoker box 100 contacting the respective top portions of three neighboring grease deflection bars 1304. In other examples, the smoker box 100 can instead be located within the cookbox 1302 of the grill 1300 at a vertical position above the grease deflection bar(s) 1304 and also above the cooking grate(s) 1306 of the grill 1300, with the base 102 (e.g., the bottom wall 206 of the base 102) of the smoker box 100 contacting the respective top portion(s) of the cooking grate(s) 1306.

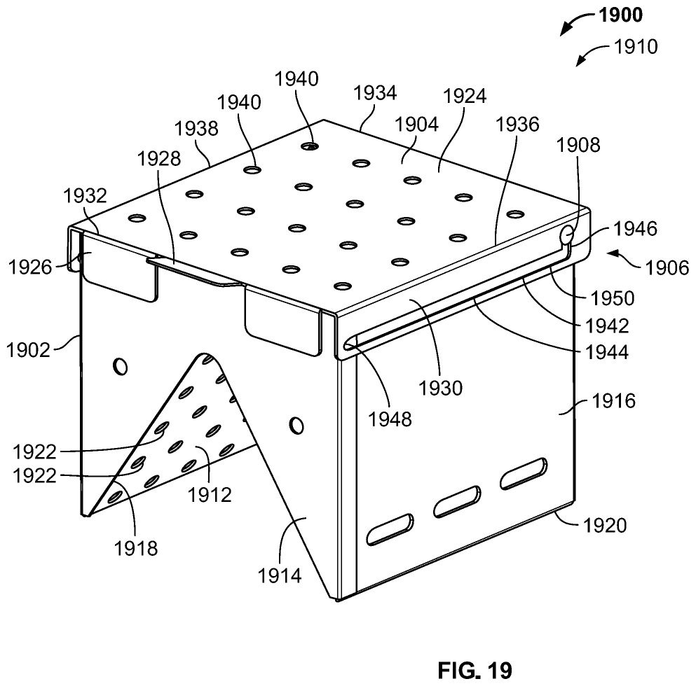

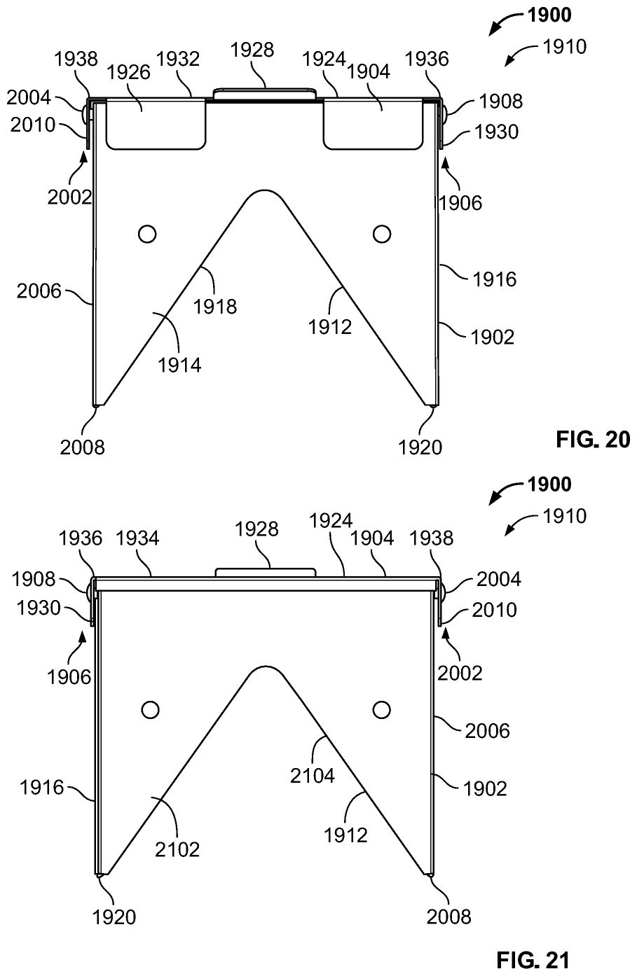

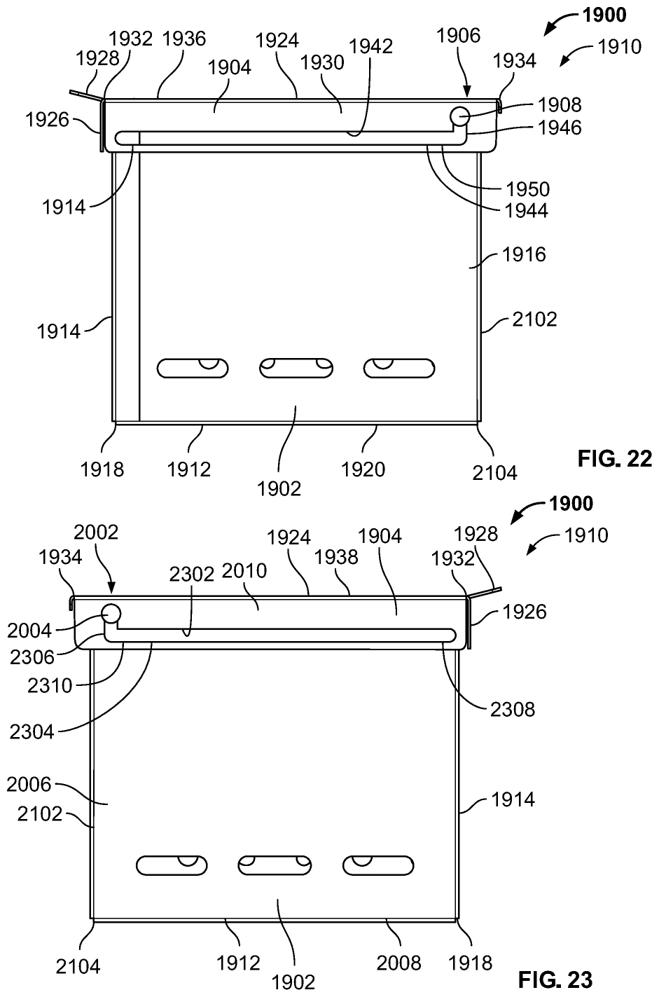

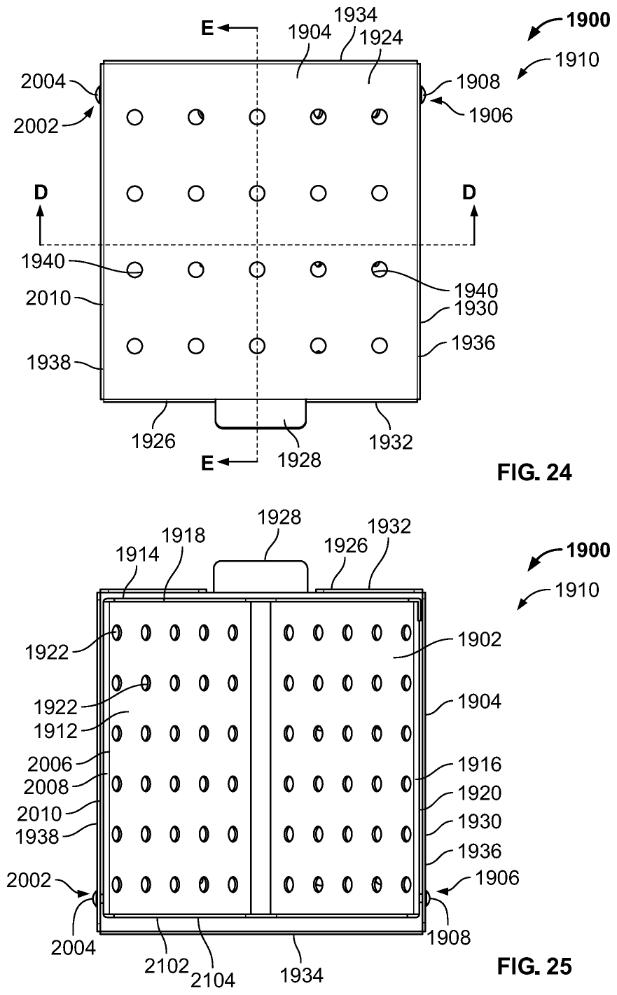

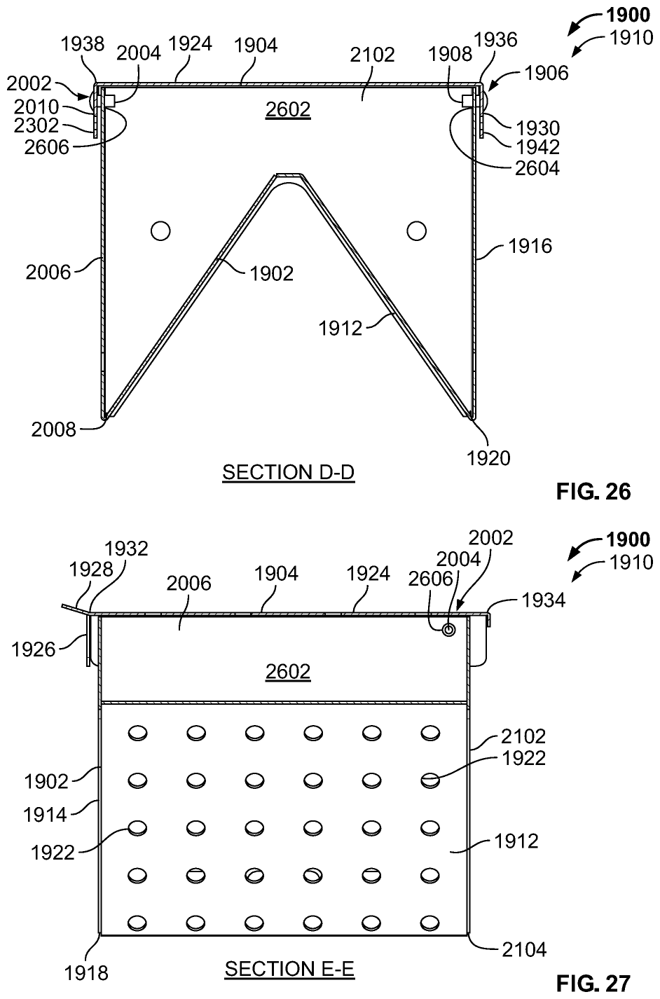

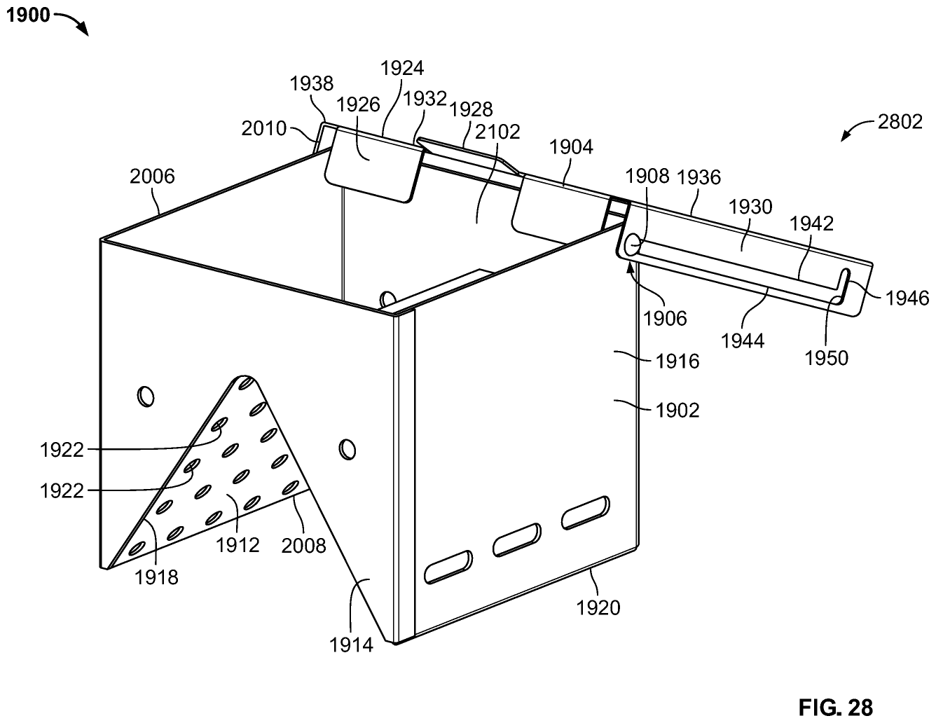

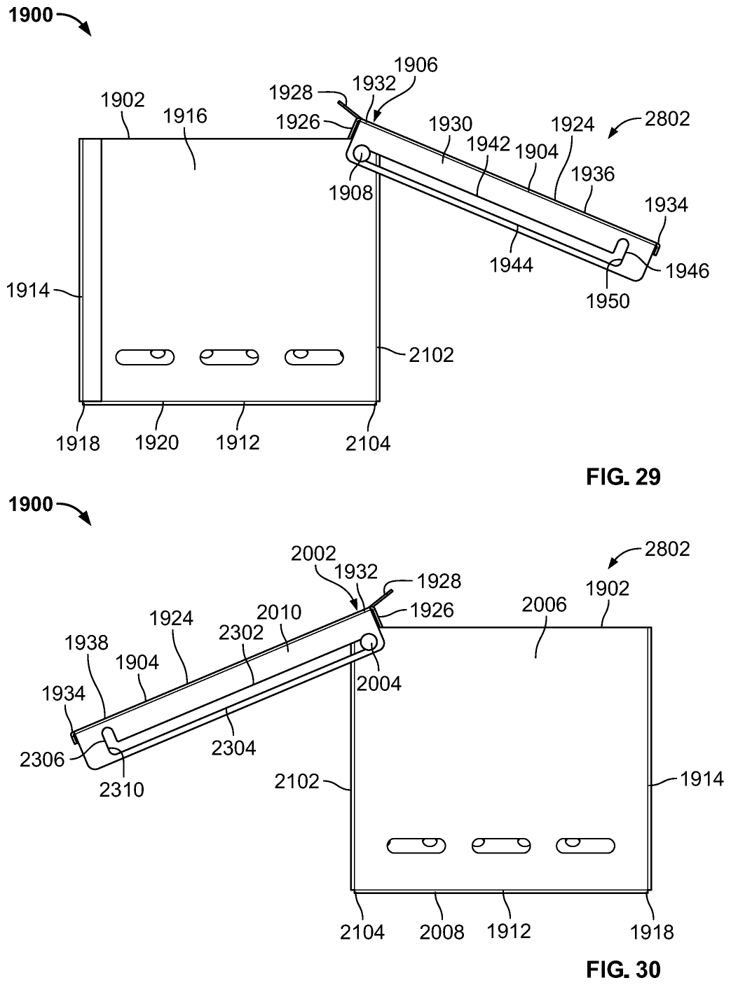

FIG. 19 is a perspective view of another example smoker box 1900 constructed in accordance with teachings of this disclosure, with an example lid 1904 of the smoker box 1900 shown in an example closed position 1910 relative to an example base 1902 of the smoker box 1900. FIG. 20 is a front view of the smoker box 1900 of FIG. 19, with the lid 1904 of the smoker box 1900 shown in the closed position 1910 of FIG. 19. FIG. 21 is a rear view of the smoker box 1900 of FIGS. 19 and 20, with the lid 1904 of the smoker box 1900 shown in the closed position 1910 of FIGS. 19 and 20. FIG. 22 is a right side view of the smoker box 1900 of FIGS. 19-21, with the lid 1904 of the smoker box 1900 shown in the closed position 1910 of FIGS. 19-21. FIG. 23 is a left side view of the smoker box 1900 of FIGS. 19-22, with the lid 1904 of the smoker box 1900 shown in the closed position 1910 of FIGS. 19-22. FIG. 24 is a top view of the smoker box 1900 of FIGS. 19-23, with the lid 1904 of the smoker box 1900 shown in the closed position 1910 of FIGS. 19-23. FIG. 25 is a bottom view of the smoker box 1900 of FIGS. 19-24, with the lid 1904 of the smoker box 1900 shown in the closed position 1910 of FIGS. 19-24. FIG. 26 is a cross-sectional view of the smoker box 1900 of FIGS. 19-25 taken along section D-D of FIG. 24, with the lid 1904 of the smoker box 1900 shown in the closed position 1910 of FIGS. 19-25. FIG. 27 is a cross-sectional view of the smoker box 1900 of FIGS. 19-26 taken along section E-E of FIG. 24, with the lid 1904 of the smoker box 1900 shown in the closed position 1910 of FIGS. 19-26. FIG. 28 is a perspective view of the smoker box 1900 of FIGS. 19-27, with the lid 1904 of the smoker box 1900 shown in an example open position 2802 relative to the base 1902 of the smoker box 1900. FIG. 29 is a right side view of the smoker box 1900 of FIGS. 19-28, with the lid 1904 of the smoker box 1900 shown in the open position 2802 of FIG. 28. FIG. 30 is a left side view of the smoker box 1900 of FIGS. 19-29, with the lid 1904 of the smoker box 1900 shown in the open position 2802 of FIGS. 28 and 29.

In the illustrated example of FIGS. 19-30, the smoker box 1900 includes the base 1902, the lid 1904, an example first hinge 1906 having an example first pin 1908, and an example second hinge 2002 having an example second pin 2004. The lid 1904 of the smoker box 1900 is slidably coupled to the base 1902 of the smoker box 1900 via the first hinge 1906 and the second hinge 2002 of the smoker box 1900, with the lid 1904 being movable (e.g., slidable) relative to the base 1902 between the closed position 1910 shown in FIGS. 19-27 and the open position 2802 shown in FIGS. 28-30.

The base 1902 of the smoker box 1900 of FIGS. 19-30 defines and/or provides an example compartment 2602 that can be filled with solid-form smoking materials (e.g., wood chips, wood pellets, etc.) when the lid 1904 of the smoker box 1900 is in the open position 19002 shown in FIGS. 28-30. Once such smoking materials have been added to the compartment 2602, the lid 1904 of the smoker box 1900 can be moved (e.g., slid) from the open position 2802 shown in FIGS. 28-30 into the closed position 1910 shown in FIGS. 19-27 to retain the smoking materials within the compartment 2602, and/or to facilitate a smoke-generating process within the compartment 2602.

In the illustrated example of FIGS. 19-30, the base 1902 of the smoker box 1900 includes an example bottom wall 1912, an example front wall 1914, an example rear wall 2102, an example right sidewall 1916, and an example left sidewall 2006. The bottom wall 1912 of the base 1902 includes an example front edge 1918, an example rear edge 2104 located opposite the front edge 1918 of the bottom wall 1912, an example right edge 1920 extending between the front edge 1918 and the rear edge 2104 of the bottom wall 1912, and an example left edge 2008 located opposite the right edge 1920 of the bottom wall 1912 and extending between the front edge 1918 and the rear edge 2104 of the bottom wall 1912. The bottom wall 1912 of the base 1902 has an inverted V-shaped profile defined by the front edge 1918, the rear edge 2104, the right edge 1920, and the left edge 2008 of the bottom wall 1912. The base 1902 of the smoker box 1900 has a generally box-shaped profile that includes the inverted V-shaped profile of the bottom wall 1912 as defined by the front edge 1918, the rear edge 2104, the right edge 1920, and the left edge 2008 of the bottom wall 1912, and further defined by the front wall 1914, the rear wall 2102, the right sidewall 1916, and the left sidewall 2006.

The bottom wall 1912 of the base 1902 of FIGS. 19-30 further includes example openings 1922 (e.g., example through holes) formed in and extending through the bottom wall 1912. The openings 1922 formed in the bottom wall 1912 of the base 192 can be configured to have any size and/or any shape that is suitable for facilitating a smoke-generating process within the compartment 2602 of the smoker box 1900, while also preventing solid-form smoking materials (e.g., wood chips, wood pellets, etc.) contained within the compartment 2602 from passing through the bottom wall 1912 of the base 1902. The openings 1922 formed in the bottom wall 1912 of the base 1902 can be configured according to any layout, pattern, and or arrangement that facilitates a smoke-generating process within the compartment 2602 of the smoker box 1900.

The front wall 1914 of the base 1902 of FIGS. 19-30 extends upwardly from the front edge 1918 of the bottom wall 1912 of the base 1902. The rear wall 2102 of the base 1902 of FIGS. 19-30 extends upwardly from the rear edge 2104 of the bottom wall 1912 of the base 1902. The right sidewall 1916 of the base 1902 of FIGS. 19-30 extends upwardly from the right edge 1920 of the bottom wall 1912 of the base 1902. The left sidewall 2006 of the base 1902 of FIGS. 19-30 extends upwardly from the left edge 2008 of the bottom wall 1912 of the base 1902. In the illustrated example of FIGS. 19-30, the right sidewall 1916 and the left sidewall 2006 of the base 1902 have respective rectangular profiles defined in part by corresponding ones of the right edge 1920 and the left edge 2008 of the bottom wall 1912 of the base 1902. In other examples, one or more of the right sidewall 1916 and/or the left sidewall 2006 of the base 1902 can instead have a non-rectangular rectangular profile (e.g., a triangular profile, a trapezoidal profile, a hexagonal profile, etc.) defined in part by a corresponding one of the right edge 1920 and/or the left edge 2008 of the bottom wall 1912 of the base 1902.

The right sidewall 1916 of the base 1902 of FIGS. 19-30 includes an example opening 2604 (e.g., a through hole) formed in and extending through the right sidewall 1916, with the opening 2604 being configured to receive the first pin 1908 of the first hinge 1906. The left sidewall 2006 of the base 1902 of FIGS. 19-30 includes an example opening 2606 (e.g., a through hole) formed in and extending through the left sidewall 2006, with the opening 2606 being configured to receive the second pin 2004 of the second hinge 2002. In the illustrated example of FIGS. 19-30, the opening 2604 formed in the right sidewall 1916 of the base 1902 is coaxially aligned with the opening 2606 formed in the left sidewall 2006 of the base 1902, and the first pin 1908 of the first hinge 1906 is coaxially aligned with the second pin 2004 of the second hinge 2002.

The base 1902 of the smoker box 1900 of FIGS. 19-30 has a depth (DB) extending from the front edge 1918 of the bottom wall 1912 to the rear edge 2104 of the bottom wall 1912, and a width (WB) extending from the right edge 1920 of the bottom wall 1912 to the left edge 2008 of the bottom wall 1912. In the illustrated example of FIGS. 19-30, the base 1902 of the smoker box 1900 is configured such that the width (WB) of the base 1902 is approximately equal to the depth (DB) of the base 1902. In other examples, the base 1902 of the smoker box 1900 can instead be configured such that the depth (DB) of the base 1902 is substantially greater than or substantially less than the width (WB) of the base 1902. In the illustrated example of FIGS. 19-30, the base 1902 of the smoker box 1900 is configured such that the width (WB) of the base 1902 is large enough to facilitate seating the inverted V-shaped bottom wall 1912 of the base 1902 onto a correspondingly inverted V-shaped grease deflection bar located within a cookbox of a grill. In this regard, the inverted V-shaped profile of the bottom wall 1912 of the base 1902 can advantageously be configured to complement an inverted V-shaped profile of a grease deflection bar, as further described below.

In the illustrated example of FIGS. 19-30, the lid 1904 of the smoker box 1900 includes an example top wall 1924, an example front lip 1926, an example front tab 1928, an example right lip 1930, and an example left lip 2010. The top wall 1924 of the lid 1904 includes an example front edge 1932, an example rear edge 1934 located opposite the front edge 1932 of the top wall 1924, an example right edge 1936 extending between the front edge 1932 and the rear edge 1934 of the top wall 1924, and an example left edge 1938 located opposite the right edge 1936 of the top wall 1924 and extending between the front edge 1932 and the rear edge 1934 of the top wall 1924. The top wall 1924 of the lid 1904 has a substantially flat, planar profile defined by the front edge 1932, the rear edge 1934, the right edge 1936, and the left edge 1938 of the top wall 1924.

The top wall 1924 of the lid 1904 of FIGS. 19-30 further includes example openings 1940 (e.g., example through holes) formed in and extending through the top wall 1924. The openings 1940 formed in the top wall 1924 of the lid 1904 can be configured to have any size and/or any shape that is suitable for facilitating a smoke-generating process within the compartment 2602 of the smoker box 1900, while also preventing solid-form smoking materials (e.g., wood chips, wood pellets, etc.) contained within the compartment 2602 from passing through the top wall 1924 of the lid 1904. The openings 1940 formed in the top wall 1924 of the lid 1904 can be configured according to any layout, pattern, and or arrangement that facilitates a smoke-generating process within the compartment 2602 of the smoker box 1900.

The front lip 1926 of the lid 1904 of FIGS. 19-30 extends downwardly from the front edge 1932 of the top wall 1924 of the lid 1904. The front tab 1928 of the lid 1904 of FIGS. 19-30 extends forwardly and/or upwardly from the front edge 1932 of the top wall 1924 of the lid 1904, with the front tab 1928 being centrally located along the front edge 1932 of the top wall 1924. The right lip 1930 of the lid 1904 of FIGS. 19-30 extends downwardly from the right edge 1936 of the top wall 1924 of the lid 1904. The left lip 2010 of the lid 1904 of FIGS. 19-30 extends downwardly from the left edge 1938 of the top wall 1924 of the lid 1904. In the illustrated example of FIGS. 19-30, the front lip 1926, the front tab 1928, the right lip 1930, and the left lip 2010 of the lid 1904 have respective rectangular profiles defined in part by corresponding ones of the front edge 1932, the right edge 1936, and the left edge 1938 of the top wall 1924 of the lid 1904. In other examples, one or more of the front lip 1926, the front tab 1928, the right lip 1930, and/or the left lip 2010 of the lid 1904 can instead have a non-rectangular rectangular profile (e.g., a triangular profile, a trapezoidal profile, a hexagonal profile, etc.) defined in part by a corresponding one of the front edge 1932, the right edge 1936, and/or the left edge 1938 of the top wall 1924 of the lid 1904.

The lid 194 of the smoker box 1900 of FIGS. 19-30 has a depth (DL) extending from the front edge 1932 of the top wall 1924 to the rear edge 1934 of the top wall 1924, and a width (WL) extending from the right edge 1936 of the top wall 1924 to the left edge 1938 of the top wall 1924. In the illustrated example of FIGS. 19-30, the lid 1904 of the smoker box 1900 is configured such that the depth (DL) and the width (WL) of the lid 1904 exceed the corresponding depth (DB) and the corresponding width (WB) of the base 1902 of the smoker box 1900. In this regard, the lid 1904 of the smoker box 1900 is configured such that the depth (DL) and the width (WL) of the lid 1904 are large enough to locate the respective ones of the front edge 1932, the rear edge 1934, the right edge 1936, and the left edge 1938 of the top wall 1924 of the lid 1904 outwardly of, from, and/or relative to the corresponding respective ones of the front edge 1918, the rear edge 2104, the right edge 1920, and the left edge 2008 of the bottom wall 1912 of the base 1902 of the smoker box 1900. In this same regard, the lid 1904 of the smoker box 1900 is configured such that the depth (DL) and the width (WL) of the lid 104 are large enough to locate the respective ones of the front lip 1926, the right lip 1930, and the left lip 2010 of the lid 1904 outwardly of, from, and/or relative to the corresponding respective ones of the front wall 1914, the right sidewall 1916, and the left sidewall 2006 of the base 1902 of the smoker box 1900.

The right lip 1930 of the lid 1904 of FIGS. 19-30 includes an example slot 1942 (e.g., a slotted through hole) formed in and extending through the right lip 1930. The slot 1942 of the right lip 1930 is configured to receive the first pin 1908 of the first hinge 1906 (e.g., such that the first pin 1908 extends into and/or through the slot 1942) to slidably couple the lid 1904 of the smoker box 1900 to the base 1902 of the smoker box 1900. The slot 1942 of the right lip 1930 of the lid 1904 accordingly forms part of the first hinge 1906 of the smoker box 1900. In the illustrated example of FIGS. 19-30, the slot 1942 formed in the right lip 1930 has an L-shaped profile including and/or defined by an example linear portion 1944 and an example notch 1946 extending upwardly from the linear portion 1944 of the slot 1942. The linear portion 1944 of the slot 1942 includes an example front end 1948 and an example rear end 1950 located opposite the front end 1948 of the slot 1942. The notch 1946 of the slot 1942 is located at the rear end 1950 of the linear portion 1944 of the slot 1942.

The left lip 2010 of the lid 1904 of FIGS. 19-30 includes an example slot 2302 (e.g., a slotted through hole) formed in and extending through the left lip 2010. The slot 2302 of the left lip 2010 is configured to receive the second pin 2004 of the second hinge 2002 (e.g., such that the second pin 2004 extends into and/or through the slot 2302) to slidably couple the lid 1904 of the smoker box 1900 to the base 1902 of the smoker box 1900. The slot 2302 of the left lip 2010 of the lid 1904 accordingly forms part of the second hinge 2002 of the smoker box 1900. In the illustrated example of FIGS. 19-30, the slot 2302 formed in the left lip 2010 has an L-shaped profile including and/or defined by an example linear portion 2304 and an example notch 2306 extending upwardly from the linear portion 2304 of the slot 2302. The linear portion 2304 of the slot 2302 includes an example front end 2308 and an example rear end 2310 located opposite the front end 2308 of the slot 2302. The notch 2306 of the slot 2302 is located at the rear end 2310 of the linear portion 2304 of the slot 2302.

In the illustrated example of FIGS. 19-30, the slot 1942 formed in the right lip 1930 of the lid 1904 is coaxially aligned with the slot 2302 formed in the left lip 2010 of the lid 1904, with the slot 2302 formed in the left lip 2010 of the lid 1904 being configured as a mirror image of the slot 1942 formed in the right lip 1930 of the lid 1904. When the lid 1904 of the smoker box 1900 is in the closed position 1910 (e.g., as shown in FIGS. 19-27) relative to the base 1902 of the smoker box 1900, the first pin 1908 of the first hinge 1906 is located and/or positioned within the notch 1946 of the slot 1942 of the right lip 1930 of the lid 1904, and the second pin 2004 of the second hinge 2002 is located and/or positioned within the notch 2306 of the slot 2302 of the left lip 2010 of the lid 1904. When the lid 1904 of the smoker box 1900 is in the open position 2802 (e.g., as shown in FIGS. 28-30) relative to the base 1902 of the smoker box 1900, the first pin 1908 of the first hinge 1906 is located and/or positioned within the linear portion 1944 of the slot 1942 of the right lip 1930 of the lid 1904 (e.g., the first pin 1908 being adjacent or proximate the front end 1948 of the linear portion 1944 of the slot 1942), and the second pin 2004 of the second hinge 2002 is located and/or positioned within the linear portion 2304 of the slot 2302 of the left lip 2010 of the lid 1904 (e.g., the second pin 2004 being adjacent or proximate the front end 2308 of the linear portion 2304 of the slot 2302).

Movement (e.g., sliding movement) of the lid 1904 of the smoker box 1900 relative to the base 1902 of the smoker box 1900 between the closed position 1910 shown in FIGS. 29-27 and the open position 2802 shown in FIGS. 28-30 can be facilitated via the front tab 1928 of the lid 1904 of the smoker box 1900. In this regard, the front tab 1928 of the lid 1904 can be used to lift and/or push the lid 1904 from the closed position 1910 shown in FIGS. 19-27 into the open position 2802 shown in FIGS. 28-30. Sliding the lid 1904 from the closed position 1910 shown in FIGS. 19-27 into the open position 2802 shown in FIGS. 28-30 exposes the compartment 2602 of the smoker box 1900, as may be desired to facilitate adding and/or removing solid-form smoking materials to and/or from the compartment 2602. Conversely, the front tab 1928 of the lid 1904 can be used to pull and/or lower the lid 1904 from the open position 2802 shown in FIGS. 28-30 into the closed position 1910 shown in FIGS. 19-27. Sliding the lid 1904 from the open position 2802 shown in FIGS. 28-30 into the closed position 1910 shown in FIGS. 19-27 covers the compartment 2602 of the smoker box 1900, as may be desired to facilitate a smoke-generating process within the compartment 2602.

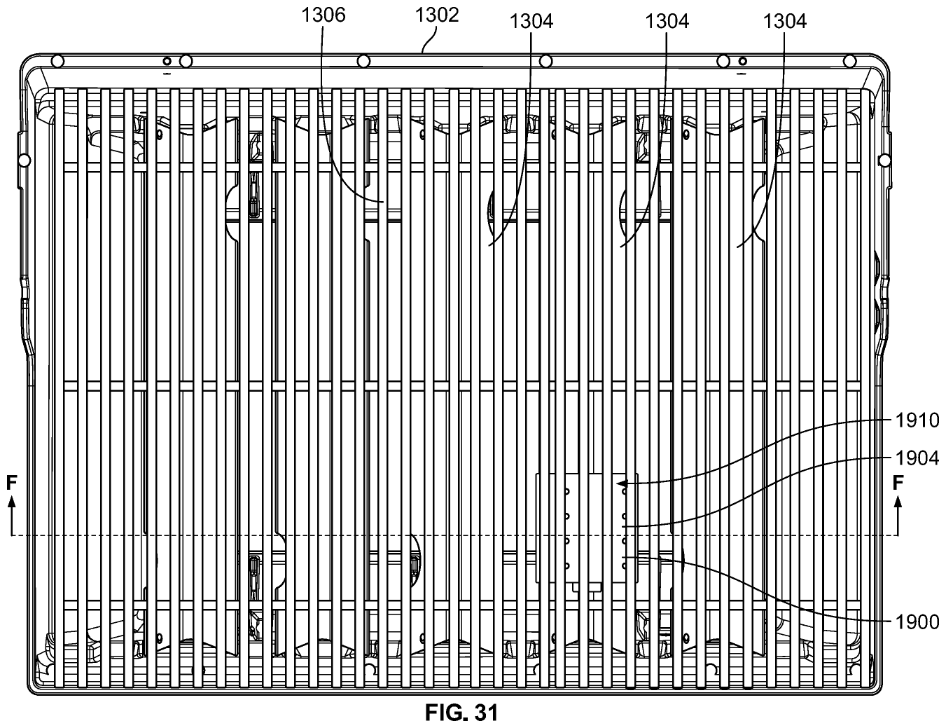

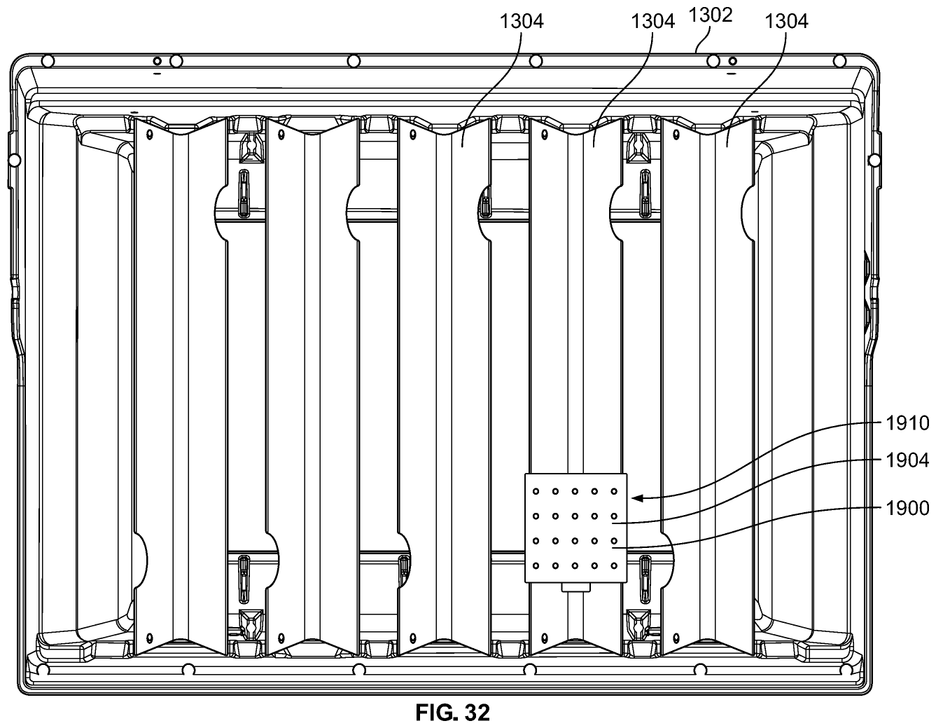

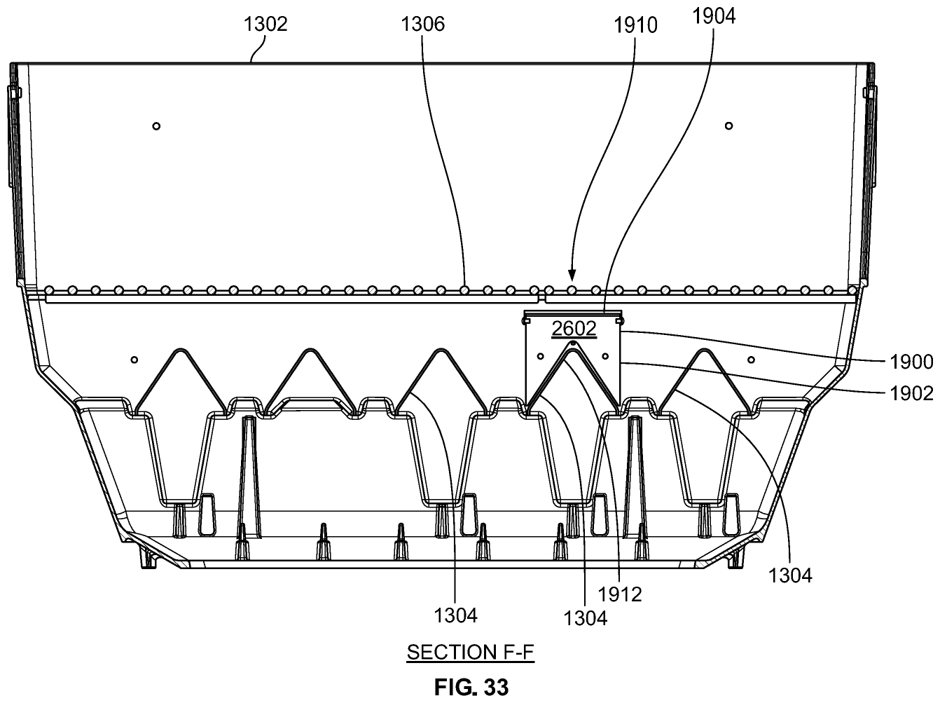

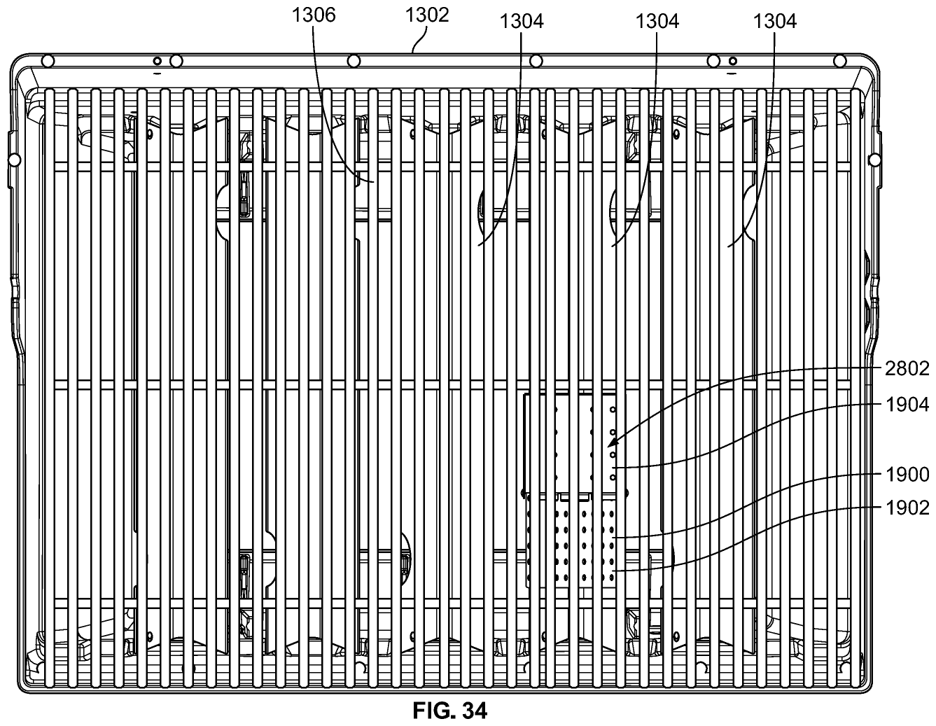

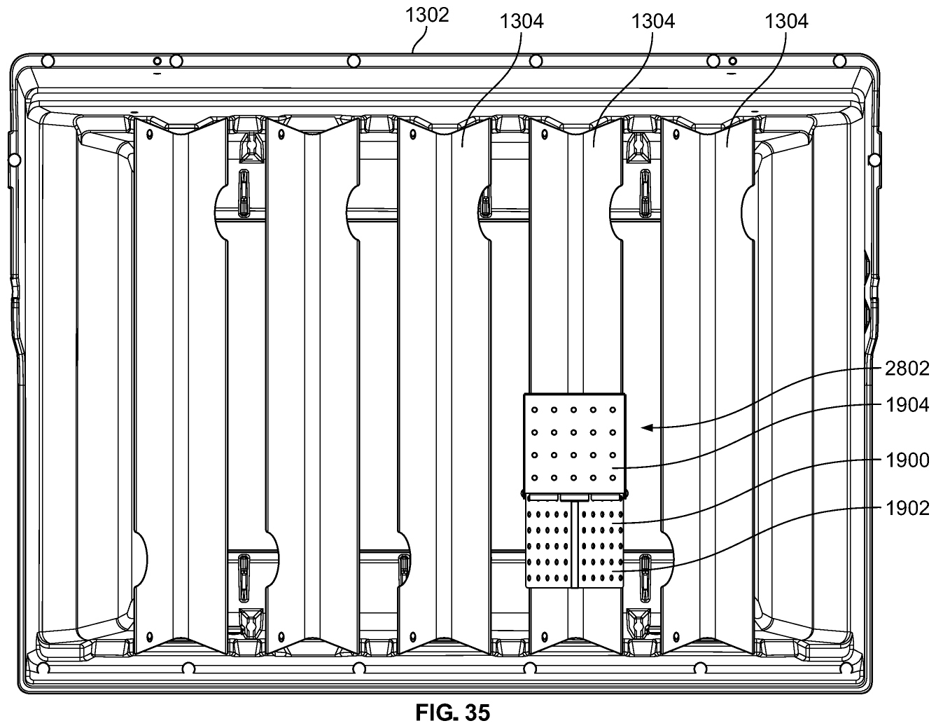

FIG. 31 is a top view of the smoker box 1900 of FIGS. 19-30 located within the cookbox 1302 of FIG. 13, with the lid 1904 of the smoker box 1900 shown in the closed position 1910 of FIGS. 19-27. FIG. 32 is a top view of the smoker box 1900 of FIGS. 19-31 located within the cookbox 1302 of FIGS. 13 and 31, with the lid 1904 of the smoker box 1900 shown in the closed position 1910 of FIGS. 19-27 and 31, and with the cooking grate(s) 1306 of FIGS. 13 and 31 shown removed from the cookbox 1302. FIG. 33 is a cross-sectional view taken along section F-F of FIG. 31 showing the smoker box 1900 of FIGS. 19-32 located within the cookbox 1302 of FIGS. 13, 31 and 32, with the lid 1904 of the smoker box 100 shown in the closed position 1910 of FIGS. 19-27, 31, and 32. FIG. 34 is a top view of the smoker box 1900 of FIGS. 19-33 located within the cookbox 1302 of FIGS. 13 and 31-33, with the lid 1904 of the smoker box 1900 shown in the open position 2802 of FIGS. 28-30. FIG. 35 is a top view of the smoker box 1900 of FIGS. 19-34 located within the cookbox 1302 of FIGS. 13 and 31-34, with the lid 1904 of the smoker box 1900 shown in the open position 2802 of FIGS. 28-30 and 34, and with the cooking grate(s) 1306 of FIGS. 13, 31, 33 and 34 shown removed from the cookbox 1302.

In the illustrated example of FIGS. 31-35, the smoker box 1900 is located within the cookbox 1302 of the grill 1300 at a vertical position above the grease deflection bar(s) 1304 and below the cooking grate(s) 1306 of the grill 1300, with the base 1902 (e.g., the bottom wall 1912 of the base 1902) of the smoker box 1900 contacting and/or seated on one of the grease deflection bars 1304. In other examples, the smoker box 1900 can instead be located within the cookbox 1302 of the grill 1300 at a vertical position above the grease deflection bar(s) 1304 and also above the cooking grate(s) 1306 of the grill 1300, with the base 1902 (e.g., the right edge 1920 and the left edge 2008 of the bottom wall 1912 of the base 1902) of the smoker box 1900 contacting the respective top portion(s) of the cooking grate(s) 1306. As shown in FIGS. 31-35, the inverted V-shaped profile of the bottom wall 1912 of the base 1902 of the smoker box 1900 is advantageously configured to complement the inverted V-shaped profile of the grease deflection bar 1304 onto which the base 1902 of the smoker box 1900 is seated.

Example smoker boxes disclosed herein have slidable lids that provide enhanced usability and consumer experience opportunities with regard to opening and/or closing the lid of the smoker box relative to the base of the smoker box. In some disclosed examples, the smoker box includes a base having a bottom wall, a front wall, a rear wall, a right sidewall, a left sidewall, a first pin coupled to the right sidewall, and a second pin coupled to the left sidewall.

In some disclosed examples, the smoker box further includes a lid slidably coupled to the base and movable between a closed position and an open position. In some disclosed examples, the lid includes a top wall, a right lip, and a left lip. In some disclosed examples, the right lip includes a first slot, the left lip includes a second slot, the first pin extends into and is slidable within the first slot, and the second pin extends into and is slidable within the second slot.

In some disclosed examples, the lid is slidably coupled to the base via a first hinge and a second hinge. In some disclosed examples, the first hinge includes the first pin and the first slot, and the second hinge includes the second pin and the second slot.

In some disclosed examples, the second pin is coaxially aligned with the first pin.

In some disclosed examples, the second slot is coaxially aligned with the first slot.

In some disclosed examples, the base defines a compartment. In some disclosed examples, the lid covers the compartment when the lid is in the closed position, and the lid exposes the compartment when the lid is in the open position.

In some disclosed examples, the bottom wall includes openings configured to enable smoke generated within the compartment to escape from the compartment through the openings. In some disclosed examples, the openings are further configured to prevent solid-form smoking materials located within the compartment from passing through the openings.

In some disclosed examples, the top wall includes openings configured to enable smoke generated within the compartment to escape from the compartment through the openings. In some disclosed examples, the openings are further configured to prevent solid-form smoking materials located within the compartment from passing through the openings.

In some disclosed examples, the first slot and the second slot each include a linear portion and a notch extending upwardly from the linear portion. In some disclosed examples, the linear portion has a front end and a rear end located opposite the front end. In some disclosed examples, the notch is located at the rear end of the linear portion.

In some disclosed examples, the lid further includes a front lip extending downwardly from the top wall.

In some disclosed examples, respective ones of the front lip, the right lip, and the left lip of the lid are located outwardly relative to corresponding respective ones of the front wall, the right sidewall, and the left sidewall of the base when the lid is in the closed position.

In some disclosed examples, the lid further includes a front tab extending forwardly or upwardly from the top wall.

In some disclosed examples, the front tab is centrally located along a front edge of the top wall.

In some disclosed examples, the bottom wall has a planar profile.

In some disclosed examples, the bottom wall has a width configured to extend across at least two grease deflection bars located within a cookbox of a grill.

In some disclosed examples, the bottom wall has an inverted V-shaped profile.

In some disclosed examples, the inverted V-shaped profile of the bottom wall is configured to complement an inverted V-shaped profile of a grease deflection bar located within a cookbox of a grill

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A smoker box, comprising:
a base including a bottom wall, a front wall extending upwardly from the bottom wall, a rear wall extending upwardly from the bottom wall, a right sidewall extending upwardly from the bottom wall, a left sidewall extending upwardly from the bottom wall, a first pin coupled to the right sidewall, and a second pin coupled to the left sidewall; and
a lid slidably coupled to the base and movable between a closed position and an open position, the lid including a top wall, a right lip extending downwardly from the top wall, and a left lip extending downwardly from the top wall, the right lip including a first slot, the left lip including a second slot, the first pin extending into and slidable within the first slot, the second pin extending into and slidable within the second slot.

2. The smoker box of claim 1, wherein the lid is slidably coupled to the base via a first hinge and a second hinge, the first hinge including the first pin and the first slot, the second hinge including the second pin and the second slot.

3. The smoker box of claim 1, wherein the second pin is coaxially aligned with the first pin.

4. The smoker box of claim 1, wherein the second slot is coaxially aligned with the first slot.

5. The smoker box of claim 1, wherein the base defines a compartment, the lid covering the compartment when the lid is in the closed position, the lid exposing the compartment when the lid is in the open position.

6. The smoker box of claim 5, wherein the bottom wall includes openings configured to enable smoke generated within the compartment to escape from the compartment through the openings, the openings further configured to prevent solid-form smoking materials located within the compartment from passing through the openings.

7. The smoker box of claim 5, wherein the top wall includes openings configured to enable smoke generated within the compartment to escape from the compartment through the openings, the openings further configured to prevent solid-form smoking materials located within the compartment from passing through the openings.

8. The smoker box of claim 1, wherein the first slot and the second slot each include a linear portion and a notch extending upwardly from the linear portion, the linear portion having a front end and a rear end located opposite the front end, the notch located at the rear end of the linear portion.

9. The smoker box of claim 1, wherein the lid further includes a front lip extending downwardly from the top wall.

10. The smoker box of claim 9, wherein respective ones of the front lip, the right lip, and the left lip of the lid are located outwardly relative to corresponding respective ones of the front wall, the right sidewall, and the left sidewall of the base when the lid is in the closed position.

11. The smoker box of claim 1, wherein the lid further includes a front tab extending forwardly or upwardly from the top wall.

12. The smoker box of claim 11, wherein the front tab is centrally located along a front edge of the top wall.

13. The smoker box of claim 1, wherein the bottom wall has a planar profile.

14. The smoker box of claim 13, wherein the bottom wall has a width configured to extend across at least two grease deflection bars located within a cookbox of a grill.

15. The smoker box of claim 1, wherein the bottom wall has an inverted V-shaped profile.

16. The smoker box of claim 15, wherein the inverted V-shaped profile of the bottom wall is configured to complement an inverted V-shaped profile of a grease deflection bar located within a cookbox of a grill.
